(19) United States
(12) Patent Application Publication
(10) Pub. No.: US 2019/0090081 A1
(43) Pub. Date: Mar. 21, 2019

(54) GENERATING AN AIR INTERFACE PACKET FOR A LOW ENERGY SHORT-RANGE COMMUNICATION DEVICE

(71) Applicant: QUALCOMM Incorporated, San Diego, CA (US)

(72) Inventors: Robin HEYDON, Cambridge (GB); Joel LINSKY, San Diego, CA (US); Le LUONG, San Diego, CA (US); Koorosh AKHAVAN, San Diego, CA (US); Brian REDDING, Urbana, IL (US)

(21) Appl. No.: 15/709,246

(22) Filed: Sep. 19, 2017

(51) Int. Cl. H04W 4/00; H04L 27/20; H04L 29/06

(52) U.S. Cl. CPC H04W 4/008; H04L 69/22; H04L 27/20

(57) ABSTRACT

Using the modulation scheme and/or coding techniques of traditional BLE may limit not only the data rate, but also limit the amount that the transmit power of a BLE air interface packet can be reduced due to receiver sensitivity. Namely, the lowest signal power level from which a receiving device may obtain information without meeting a BER threshold may limit the amount that the transmit power at the transmitter side can be reduced. There exists a need to transmit a BLE air interface packet using a modulation rate that is greater than 1 Mbps or 2 Mbps, enables a further reduction in transmit power, and/or enables an increase in receiver sensitivity. The present disclosure provides a solution by applying a coding technique and a PSK modulation scheme to a BLE air interface packet that increases data rate and reduces the sensitivity of the receiving device as compared to traditional BLE.

### BACKGROUND

### Field

The present disclosure relates generally to communication systems, and more particularly, to generating a Bluetooth® low-energy (BLE) air interface packet that may be transmitted using a data rate that is greater than the data rate of a traditional BLE device.

### Background

A wireless personal area network (WPAN) is a personal, short-range area wireless network for interconnecting devices centered around a specific distance from a user. WPANs have gained popularity because of the flexibility and convenience in connectivity that WPANs provide. WPANs, such as those based on short-range communication protocols (e.g., a Bluetooth® (BT) protocol, BLE protocol, a Zigbee® protocol, etc.), provide wireless connectivity to peripheral devices by providing short-range wireless links that allow connectivity within a specific distance (e.g., 5 meters, 10 meter, 20 meters, 100 meters, etc.).

BT is a short-range wireless communication protocol that supports a WPAN between a central device (e.g., a master device) and at least one peripheral device (e.g., a slave device). Power consumption associated with BT communications may render BT impractical in certain applications, such as applications in which an infrequent transfer of data occurs.

To address the power consumption issue associated with BT, BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. Example applications that use BLE include battery-operated sensors and actuators in various medical, industrial, consumer, and fitness applications that connect to devices such as BLE enabled smart phones, tablets, and laptops. While traditional BLE offers certain advantages, there exists a need for further improvements in BLE technology.

For example, the data rate of a traditional BLE radio located in a BLE device may be limited to, e.g., 1 Mbps or 2 Mbps. In certain applications, such as the transmission of audio packets, a data rate of 1 Mbps or 2 Mbps may be inadequate for an audio packet to be successfully received by a receiving device. In addition, using the modulation scheme and/or coding techniques of traditional BLE may limit not only the data rate, but also limit the amount that the transmitting device can reduce the transmit power of a BLE air interface packet due to a limited sensitivity at the receiving device. The receiving device sensitivity may be correlated with the lowest signal power level from which the receiving device may obtain information from a BLE air interface packet without meeting a Bit Error Rate (BER) threshold. Hence, the receiving device sensitivity may limit the amount that the transmit power for a BLE air interface packet can be reduced.

There exists a need for a BLE device that is able to transmit a BLE air interface packet using a modulation rate that is greater than 1 Mbps, enables a further reduction in transmit power, and enables an increase in receiver sensitivity.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. Example applications that use BLE include battery-operated sensors and actuators in various medical, industrial, consumer, and fitness applications, often connecting to devices such as BLE enabled smart phones, tablets, and laptops. While traditional BLE offers certain advantages, there exists a need for further improvements in BLE technology.

For example, the data rate of a traditional BLE radio located in a BLE device may be limited to, e.g., 1 Mbps or 2 Mbps. In certain applications, such as the transmission of audio packets, a data rate of 1 Mbps or 2 Mbps may be inadequate for an audio packet to be successfully received by a receiving device. In addition, using the modulation scheme and/or coding techniques of traditional BLE may limit not only the data rate, but also limit the amount that the transmitting device can reduce the transmit power of a BLE air interface packet due to a limited sensitivity at the receiving device. The receiving device sensitivity may be correlated with the lowest signal power level from which the receiving device may obtain information from a BLE air interface packet without meeting a BER threshold. Hence, the receiving device sensitivity may limit the amount that the transmit power for a BLE air interface packet can be reduced.

There exists a need for a BLE device that is able to transmit a BLE air interface packet using a modulation rate that is greater than 1 Mbps or 2 Mbps, that enables a further reduction in transmit power, and/or that enables an increase in receiver sensitivity.

The present disclosure provides a solution by applying a coding technique and a Phase Shift Keying (PSK) modulation scheme to a BLE air interface packet that may increase the data rate and reduce the sensitivity of the receiving device as compared to traditional BLE.

In an aspect of the disclosure, a method, a computer-readable medium, and an apparatus are provided. The apparatus may generate a coded access address for an air interface packet. In certain aspects, the apparatus may generate the coded access address for the air interface packet by generating an access address with a first number of bits. In certain other aspects, the apparatus may generate the coded access address for the air interface packet by appending a second number of bits to the first number of bits of the access address to generate an extended access address. In certain other aspects, the apparatus may generate the coded access address for the air interface packet by pre-scrambling the extended access address using a third number of least significant bits (LSBs) of a pseudo-noise (PN) sequence to generate a pre-scrambled access address. The PN sequence may include a fourth number of bits. In certain other aspects, the apparatus may generate the coded access address for the air interface packet by encoding the pre-scrambled access address such that the encoded pre-scrambled access address includes a same number of bits as the fourth number of bits in the PN sequence. In certain other aspects, the apparatus may generate the coded access address for the air interface packet by post-scrambling the encoded pre-scrambled access address using the PN sequence with the fourth number of bits to generate the coded access address. The coded access address may include the same number of bits as the fourth number of bits in the PN sequence. The apparatus may generate the air interface packet including the coded access address. The apparatus may transmit the air interface packet using short-range communications to a second device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WPAN in accordance with certain aspects of the disclosure.

FIG. 2 is block diagram of a BLE device in accordance with certain aspects of the disclosure.

FIG. 3 is a diagram illustrating BLE protocol stack that may be implemented by a BLE device in accordance with certain aspects of the disclosure.

FIG. 4 is a diagram illustrating an air interface packet that may be generated in accordance with certain aspects of the disclosure.

FIG. 5 is a diagram illustrating a linear feedback shift register (LFSR) that may be used to generate a cyclic redundancy check (CRC) for an air interface packet in accordance with certain aspects of the disclosure.

FIGS. 6A and 6B illustrate a data flow that may be used to generate an air interface packet in accordance with certain aspects of the disclosure.

FIG. 7 is a diagram illustrating an encoder that may be used to encode a pre-scrambled access address sequence and determine parity bits in accordance with certain aspects of the disclosure.

FIGS. 8A and 8B are a flowchart of a method of wireless communication.

FIG. 9 is a conceptual data flow diagram illustrating the data flow between different means/components in an exemplary apparatus.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

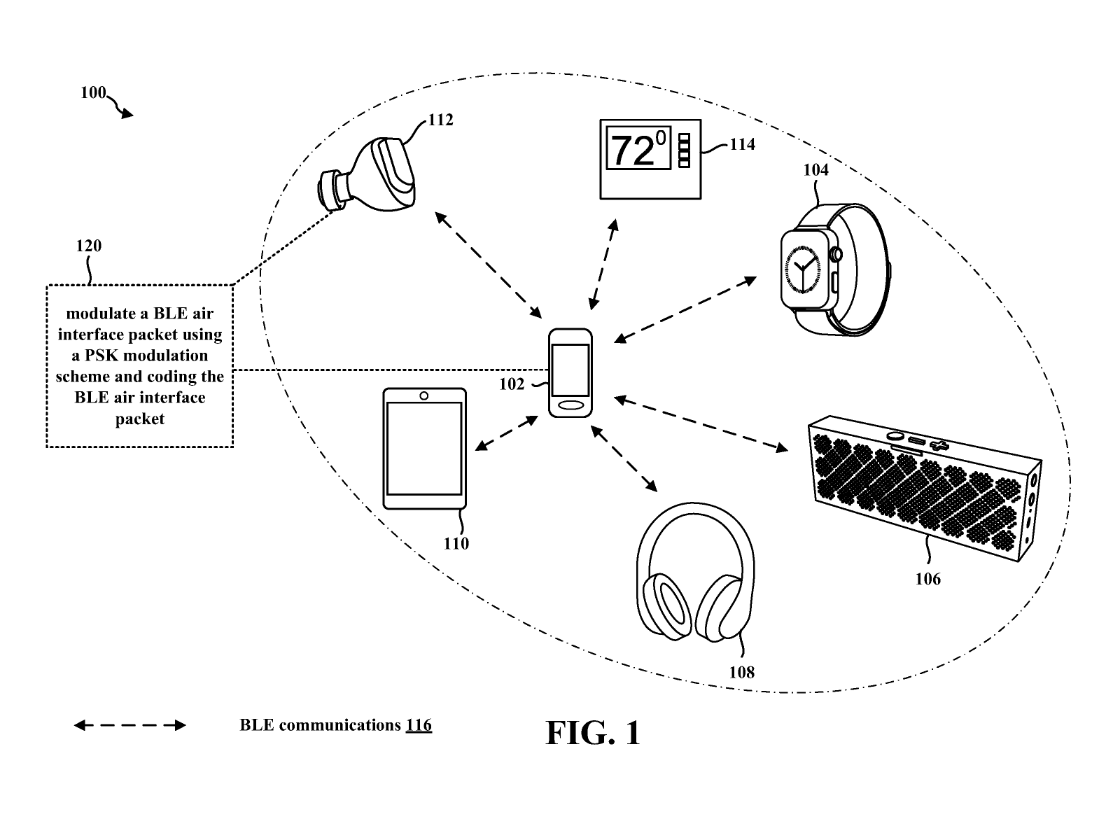

FIG. 1 illustrates an example WPAN 100 in accordance with certain aspects of the disclosure. Within the WPAN 100, a central device 102 may connect to and perform BLE communications 116 with one or more peripheral devices 104, 106, 108, 110, 112, 114 using a BLE protocol. The BLE protocol is a specification that enables radio frequency communication operating within the globally accepted 2.4 GHz Industrial, Scientific & Medical (ISM) band. The traditional BLE protocol supports a physical layer (PHY) bit rate of 1 Mbps or 2 Mbps over a range of, e.g., 5 to 15 meters.

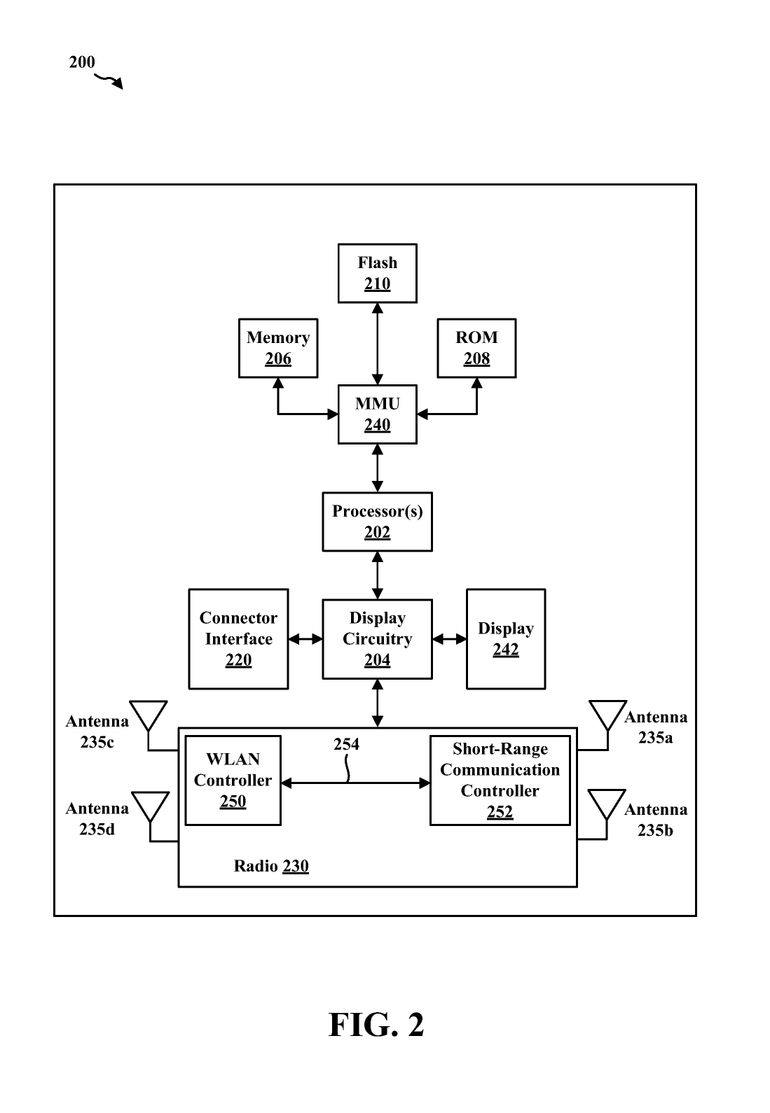

The central device 102 may include suitable logic, circuitry, interfaces, processors, and/or code that may be used to communicate with one or more peripheral devices 104, 106, 108, 110, 112, 114 using the BLE protocol or the modified BLE protocol as described below with reference to FIGS. 2-10. The central device 102 may operate as an initiator to request establishment of a Link Layer (LL) connection with an intended peripheral device 104, 106, 108, 110, 112, 114.

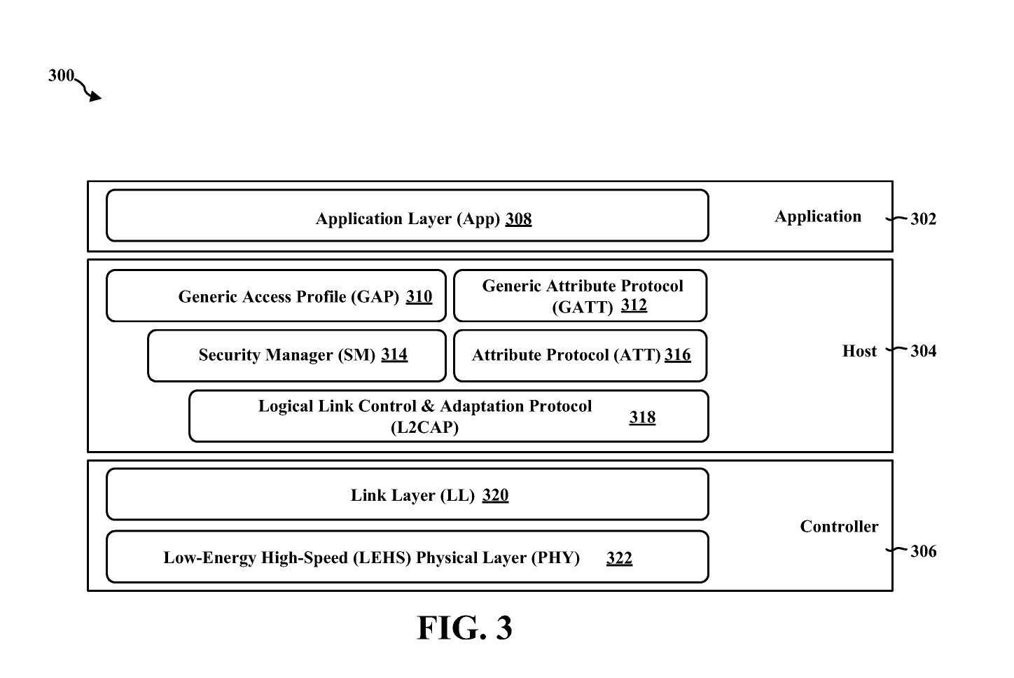

A LL in the BLE protocol stack (e.g., see FIG. 3) provides, as compared to BT, ultra-low power idle mode operation, simple device discovery and reliable point-to-multipoint data transfer with advanced power-save and encryption functionalities. After a requested LL connection is established, the central device 102 may become a master device and the intended peripheral device 104, 106, 108, 110, 112, 114 may become a slave device for the established LL connection. As a master device, the central device 102 may be capable of supporting multiple LL connections at a time to various peripheral devices 104, 106, 108, 110, 112, 114 (slave devices). The central device 102 (master device) may be operable to manage various aspects of data packet communication in a LL connection with an associated peripheral device 104, 106, 108, 110, 112, 114 (slave). For example, the central device 102 may be operable to determine an operation schedule in the LL connection with a peripheral device 104, 106, 108, 110, 112, 114 (slave device). The central device 102 may be operable to initiate a BLE air interface packet exchange sequence in the LL connection. LL connections may be configured to run periodic connection events in data channels. Air interface packet transmissions may take place within connection events.

In certain configurations, the central device 102 may be configured to transmit the first air interface packet in each connection event to an intended peripheral device 104, 106, 108, 110, 112, 114. The central device 102 may utilize a polling scheme to poll the intended peripheral device 104, 106, 108, 110, 112, 114 for an air interface packet transmission in a connection event. The intended peripheral device 104, 106, 108, 110, 112, 114 may transmit an air interface packet upon receipt of an air interface packet from the central device 102.

Examples of the central device 102 include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, a thermostat, a hearing aid, a blood glucose on-body unit, an Internet-of-Things (IoT) device, or any other similarly functioning device.

Examples of the one or more peripheral devices 104, 106, 108, 110, 112, 114 include a cellular phone, a smart phone, a SIP phone, a STA, a laptop, a PC, a desktop computer, a PDA, a satellite radio, a global positioning system, a multimedia device, a video device, a digital audio player (e.g., MP3 player), a camera, a game console, a tablet, a smart device, a wearable device, a vehicle, an electric meter, a gas pump, a toaster, a thermostat, a hearing aid, a blood glucose on-body unit, an IoT device, or any other similarly functioning device. Although the central device 102 is illustrated in communication with six peripheral devices 104, 106, 108, 110, 112, 114 in the WPAN 100, the central device 102 may communicate with more or fewer than six peripheral devices within the WPAN 100 without departing from the scope of the present disclosure.

Referring again to FIG. 1, in certain aspects, the central device 102 and/or a peripheral device (e.g., peripheral device 112) may be configured to modulate a BLE air interface packet using a PSK modulation scheme and to encode the BLE air interface packet (120).

FIG. 2 is block diagram of a wireless device 200 in accordance with certain aspects of the disclosure. The wireless device 200 may correspond to, e.g., the central device 102, and/or one of the peripheral devices 104, 106, 108, 110, 112, 114 in FIG. 1. In certain configurations, the wireless device 200 may be, e.g., a BLE device.

As shown in FIG. 2, the wireless device 200 may include a processing element, such as processor(s) 202, which may execute program instructions for the wireless device 200. The wireless device 200 may also include display circuitry 204 which may perform graphics processing and provide display signals to the display 242. The processor(s) 202 may also be coupled to memory management unit (MMU) 240, which may be configured to receive addresses from the processor(s) 202 and translate the addresses to address locations in memory (e.g., memory 206, ROM 208, Flash memory 210) and/or to address locations in other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202.

As shown, the processor(s) 202 may be coupled to various other circuits of the wireless device 200. For example, the wireless device 200 may include various types of memory, a connector interface 220 (e.g., for coupling to the computer system), the display 242, and wireless communication circuitry (e.g., for Wi-Fi, BT, BLE, etc.). The wireless device 200 may include a plurality of antennas 235a, 235b, 235c, 235d, for performing wireless communication with, e.g., BLE devices.

In certain aspects, the wireless device 200 may include hardware and software components (a processing element) configured to generate a BLE air interface packet that is modulated using a PSK modulation scheme and coded, e.g., using the techniques described below with reference to FIGS. 3-10. The wireless device 200 may also comprise BLE firmware or other hardware/software for controlling BLE operations. In addition, the wireless device 200 may store and execute a WLAN software driver for controlling WLAN operations.

The wireless device 200 may be configured to implement part or all of the techniques described below with reference to FIGS. 3-10, e.g., by executing program instructions stored on a memory medium (e.g., a non-transitory computer-readable memory medium) and/or through hardware or firmware operation. In other embodiments, the techniques described below with reference to FIGS. 3-10 may be at least partially implemented by a programmable hardware element, such as an field programmable gate array (FPGA), and/or an application specific integrated circuit (ASIC).

In certain aspects, radio 230 may include separate controllers configured to control communications for various respective radio access technology (RAT) protocols. For example, as shown in FIG. 2, radio 230 may include a wireless local area network (WLAN) controller 250 configured to control WLAN communications and a short-range communications controller 252 configured to control short-range communications (e.g., BLE communications). A coexistence interface 254 (e.g., a wired interface) may be used for sending information between the WLAN controller 250 and the short-range communications controller 252.

In some aspects, one or more of the WLAN controller 250 and/or the short-range communications controller 252 may be implemented as hardware, software, firmware or some combination thereof.

In certain aspects, the WLAN controller 250 may be configured to communicate with a second device using a WLAN link using all of the antennas 235a, 235b, 235c, 235d. In certain configurations, the short-range communications controller 252 may be configured to implement a BLE protocol stack (see FIG. 3), and communicate with at least one second device using one or more of the antennas 235a, 235b, 235c, 235d. The short-range communications controller 252 may be configured to generate a BLE air interface packet that is modulated using a PSK modulation scheme.

FIG. 3 illustrates a BLE protocol stack 300 that may be implemented in a BLE device. For example, the BLE protocol stack 300 may be implemented by, e.g., one or more of processor(s) 202, memory 206, Flash memory 210, ROM 208, and/or the short-range communications controller 252 illustrated in FIG. 2.

Referring to FIG. 3, the BLE protocol stack 300 is organized into three blocks, namely, the Application block 302, the Host block 304, and the Controller block 306. Application 302 is the user application which interfaces with the other blocks and/or layers of the BLE protocol stack 300. The Host block 304 includes the upper layers of the BLE protocol stack 300, and the Controller block 306 includes the lower layers of the BLE protocol stack 300.

The Host block 304 may communicate with a BLE controller (e.g., short-range communications controller 252 in FIG. 2) in a wireless device using a Host Controller Interface (HCI) (not illustrated in FIG. 3). The HCI may also be used to interface the Controller block 306 with the Host block 304. Interfacing the Controller block 306 and the Host block 304 may enable a wide range of Host blocks to interface with the Controller block 306.

The Application block 302 may include a higher-level Application Layer (App) 308, and the BLE protocol stack 300 may run under the App 308. The Host block 304 may include a Generic Access Profile (GAP) 310, a Generic Attribute Protocol (GATT) 312, a Security Manager (SM) 314, an Attribute Protocol (ATT) 316, and a Logical Link Control and Adaptation Protocol (L2CAP) 318. The Controller block 306 may include a LL 320 and a Low-Energy High-Speed (LEHS) Physical Layer (PHY) 322.

To support new applications (e.g., IoT applications, audio applications, etc.), the LEHS PHY 322 of the present disclosure may support an increased range and data rate as compared to the PHY layer in a traditional BLE protocol stack. The LEHS PHY 322 may define the mechanism for transmitting a bit stream over a physical link that connects BLE devices. The bit stream may be grouped into code words or symbols, and converted to a BLE air interface packet that is transmitted over a transmission medium. The LEHS PHY 322 may provide an electrical, mechanical, and procedural interface to the transmission medium. The shapes and properties of the electrical connectors, the frequency band used for transmission, the modulation scheme, and similar low-level parameters may be specified by the LEHS PHY 322.

The LEHS PHY 322 of the present disclosure may use PSK modulation schemes rather than the Frequency Shift Keying (FSK) modulation scheme used in traditional BLE. Modulation schemes may be used to convey data by changing some aspect of a base signal and/or the carrier wave in response to a data signal. In the case of PSK, the phase is changed to represent the data signal. In PSK, the constellation points chosen are usually positioned with a uniform angular spacing around a circle. The uniform angular spacing may provide maximum phase-separation between adjacent constellation points and thus the best immunity to a high BER (e.g., a BER above a threshold level). The adjacent points are positioned on a circle so that each of the adjacent points can be transmitted with the same power.

Any number of phases may be used to construct a PSK constellation but 8PSK is usually the highest order PSK constellation deployed. With more than 8 phases, the BER may become too high. Although any number of phases may be used, given that the constellation usually represents binary data means that the number of symbols is usually a power of 2 to allow an integer number of bits per symbol.

In aspects of the present disclosure, five modes of operation (e.g., LEHS2, LEHS3, LEHS4, LEHS5, and LEHS6) may be selected where two modes (e.g., LEHS4 and LEHS6) have no coding and 3 modes (e.g., LEHS2, LEHS3, and LEHS5) have coding. Table 1 below lists a summary of features associated with modulating and/or transmitting a BLE air interface packet (e.g., a LEHS packet). The summary of features may include, e.g., a modulation scheme, code type, generator polynomial (Gen Poly), puncturing matrix, data rate, signal-to-noise ratio, and receiver sensitivity.

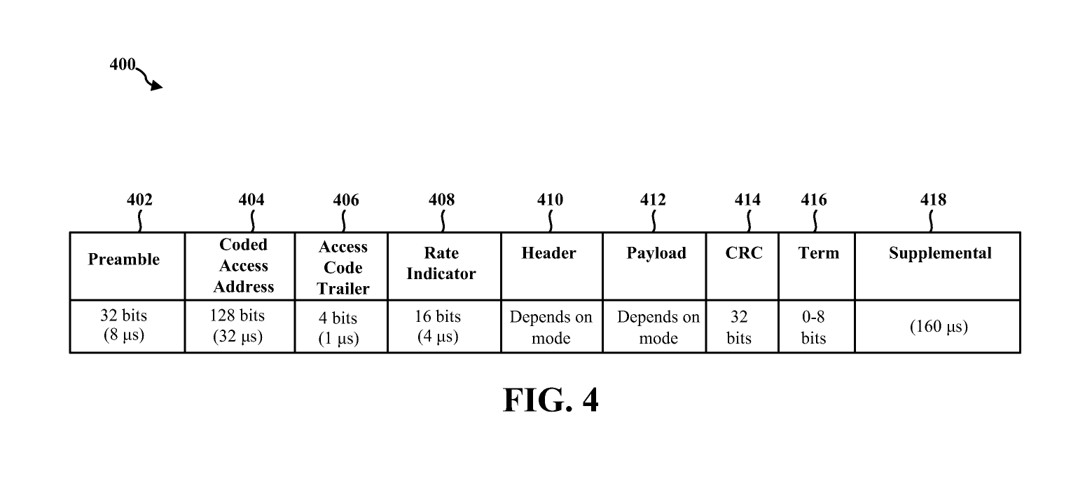

By using the PSK modulation schemes seen below in Table 1, the data rate for a BLE air interface packet may be increased as compared to the data rates associated with the FSK modulation schemes used in traditional BLE. Further, by encoding the BLE air interface packet as described with reference to FIGS. 4-10, the sensitivity of the receiving device may be increased. Thus, by increasing the receiving device sensitivity, the power level of a transmitted BLE air interface packet may be reduced without increasing the BER. Hence, the techniques described herein may provide an increase in data rate and a reduction in transmit power for a BLE air interface packet may be provided as compared to traditional BLE.

TABLE 1
LEHS Packet Summary

| | | | | Puncturing | Data | | |
|---|---|---|---|---|---|---|---|
| Mode | Modulation | Code Type | Gen Poly | Matrix | Rate | SNR | Sensitivity |
| LEHS2 | π/4-DQPSK | 1/2 | [23, 35] | None | 2 Mbps | 4.8 | −102.8 |
| LEHS3 | π/4-DQPSK | 3/4 | [23, 35] | [101; | 3 Mbps | 7.3 | −100.3 |
| | | | | 101] | | | |
| LEHS4 | π/4-DQPSK | None | NA | NA | 4 Mbps | 11.8 | −95.8 |
| LEHS5 | 8PSK | 5/6 | [25, 33, 37] | [10100; | 5 Mbps | 13.3 | −94.3 |
| | | | | 10100; | | | |
| | | | | 10100] | | | |
| LEHS6 | 8PSK | None | NA | NA | 6 Mbps | 16.8 | −90.8 |

Each of modes of operation (e.g., LEHS2, LEHS3, LEHS4, LEHS5, LEHS6) may use a 2 MHz bandwidth.

As seen above in Table 1, the modulation scheme associated with each of the three modes with coding (e.g., LEHS2, LEHS3, and LEHS4) may include a π/4-differential quadrature PSK (DQPSK), and the modulation scheme associated with the two modes without coding (e.g., LEHS5 and LEHS6) may include 8PSK.

In DQPSK, the phase-shifts may be 0°, 90°, 180°, −90° corresponding to bit patterns “00”, “01”, “11”, “10”, respectively. π/4-DQPSK is a differential format of PSK where the bits for a given symbol are determined by the phase change from the previous symbol. “π/4” adds a π/4 offset to the phase changes compared with the phase changes in plain DQPSK. Consequently, there are a total of 8 state positions (compared to the 4 state positions for DQPSK). The state positions for symbols alternate between the four 45° states normally used by QPSK and four on-axis states. In, π/4-DQPSK the phase changes are π/4, 3π/4, −π/4, −3π/4 corresponding to “00”, “01”, “11”, “10”, respectively.

Table 2 below may be used, e.g., by the LEHS PHY 322 to define a QPSK and DQPSK bit to phase mapping between bits b and phase ϕₖ, where k represents the modulation symbol index or symbol number.

TABLE 2
QPSK and DQPSK Bit to Phase Mapping

| b₃ₖ₋₁ | b₃ₖ | φₖ |
|---|---|---|
| 0 | 0 | 0 |
| 0 | 1 | π/2 |
| 1 | 1 | π |

Table 3 seen below may be used, e.g., by the LEHS PHY 322 to define a 8PSK and D8PSK bit to phase mapping between bits b and phase ϕₖ, where k represents the modulation symbol index or symbol number.

TABLE 3
8PSK and D8PSK Bit to Phase Mapping

| b₃ₖ₋₂ | b₃ₖ₋₁ | b₃ₖ | φₖ |
|---|---|---|---|
| 0 | 0 | 0 | 0 |
| 0 | 0 | 1 | π/4 |
| 0 | 1 | 1 | π/2 |
| 0 | 1 | 0 | 3π/4 |
| 1 | 1 | 0 | π |
| 1 | 1 | 1 | −3π/4 |
| 1 | 0 | 1 | −π/2 |
| 1 | 0 | 0 | −π/4 |

Table 4 seen below may be used by, e.g., the LEHS PHY 322 to define a relationship between phase ϕₖ and modulation symbol sₖ for each of π/4-DQPSK, π/4-QPSK, D8PSK, and 8PSK, where k represents the modulation symbol index or symbol number.

TABLE 4
Relationship between phase φₖ and modulation symbol sₖ

| π/4-DQPSK | π/4-QPSK | D8PSK | 8PSK |
|---|---|---|---|
| sₖ = sₖ₋₁ | sₖ = exp{j(φₖ + | sₖ = sₖ₋₁ exp{jφₖ} | sₖ = exp{jφₖ} |
| exp{j(φₖ + π/4)} | mod(k,2)π/4)} | | |

Additional details related to the modulation and/or encoding of a BLE air interface packet that may be implemented by the LEHS PHY 322 are provided below with respect to FIGS. 4-10.

The LL 320 is responsible for low level communication over the LEHS PHY 322. The LL 320 manages the sequence and timing of transmitted and received BLE air interface packets, and using a LL protocol, communicates with other devices regarding connection parameters and data flow control. The LL 320 may also provide gate keeping functionality to limit exposure and data exchange with other devices. If filtering is configured, the LL 320 maintains a list of allowed devices and will ignore all requests for data exchange from devices not in the list. The LL 320 may also reduce power consumption. The LL 320 may use a HCI (not shown in FIG. 3) to communicate with upper layers of the BLE protocol stack 300. The LL 320 may include a proprietary LL that may be used to discover peer devices (e.g., other proprietary devices), and establish a secure communication channel therewith. In certain aspects, either the LL 320 and/or the proprietary LL may be used to generate a BLE air interface packet as discussed below with reference to FIG. 4.

The L2CAP 318 may encapsulate multiple protocols from the upper layers into a BLE air interface packet format (and vice versa). The L2CAP 318 may also break large BLE air interface packets, received from the upper layers for transmission, into segments that fit into a maximum payload size (e.g., 27 bytes) on the transmit side. Similarly, the L2CAP 318 may receive multiple BLE air interface packets that have been segmented, and the L2CAP 318 may combine the segments into a single BLE air interface packet that will be sent to the upper layers.

The ATT 316 is a client/server protocol based on attributes associated with a BLE device configured for a particular purpose (e.g., monitoring heart rate, temperature, broadcasting advertisements, etc.). The attributes may be discovered, read, and written by peer devices. The set of operations which are executed over ATT 316 may include, but are not limited to, error handling, server configuration, find information, read operations, write operations, queued writes, etc. The ATT 316 may form the basis of data exchange between BLE devices.

The SM 314 is responsible for device pairing and key distribution. A security manager protocol implemented by the SM 314 may define how communications with the SM of a counterpart BLE device are performed. The SM 314 provides additional cryptographic functions that may be used by other components of the BLE protocol stack 300. The architecture of the SM 314 used in BLE may be designed to minimize recourse requirements for peripheral devices by shifting work to a more powerful central device. BLE uses a pairing mechanism for key distribution. The SM 314 may provide a mechanism to encrypt the data and also to provide data authentication.

The GATT 312 describes a service framework using the attribute protocol for discovering services, and for reading and writing characteristic values on a peer device. The GATT 312 interfaces with the App 308 through the App's profiles. The App 308 profile defines the collection of attributes and permissions needed for the attributes to be used in BLE communications. One of the main benefits of BT technology is device interoperability. To assure interoperability, use of a standardized wireless protocol to transfer bytes of information may be inadequate, and hence, sharing data representation levels may be needed. In other words, both devices may send or receive data in the same format using the same data interpretation based on intended device functionality.

The GAP 310 provides an interface for the App 308 to initiate, establish, and manage connection with other BLE devices.

BLE may be deployed in various applications in which an infrequent transfer of data occurs. BLE exploits the infrequent transfer of data by using a low duty cycle operation, and switching at least one of the central device and/or peripheral device(s) to a sleep mode in between data transmissions. Example applications that use BLE include battery-operated sensors and actuators in various medical, industrial, consumer, and fitness applications, often connecting to devices such as BLE enabled smart phones, tablets, and laptops. While traditional BLE offers certain advantages, there exists a need for further improvements in BLE technology.

For example, the data rate of a traditional BLE radio located in a BLE device may be limited to, e.g., 1 Mbps or 2 Mbps. In certain applications, such as the transmission of audio packets, a data rate of 1 Mbps or 2 Mbps may be inadequate for an audio packet to be successfully received by a receiving device. In addition, using the modulation scheme and/or coding techniques of traditional BLE may limit not only the data rate, but also limit the amount that the transmitting device can reduce the transmit power of a BLE air interface packet due to a limited sensitivity at the receiving device. The receiving device sensitivity may be correlated with the lowest signal power level from which the receiving device may obtain information from a BLE air interface packet without meeting a BER threshold. Hence, the receiving device sensitivity may limit the amount that the transmit power for a BLE air interface packet can be reduced with respect to a traditional BLE devices.

There exists a need for a BLE device that is able to transmit a BLE air interface packet using a modulation rate that is greater than 1 Mbps or 2 Mbps, that may enable a further reduction in transmit power, and that may enable an increase in receiver sensitivity.

The present disclosure provides a solution by applying a coding technique and a PSK modulation scheme to a BLE air interface packet that increases data rate and increases the sensitivity of the receiving device as compared to traditional BLE.

FIG. 4 is a diagram illustrating an air interface packet 400 in accordance with certain aspects of the present disclosure. As seen in FIG. 4, the air interface packet 400 may include a preamble 402, a coded access address 404, an access code trailer 406, a rate indicator 408, a header 410, a payload 412, a CRC 414, a termination portion (TERM) 416, and a supplemental portion 418.

The air interface packet 400 may include an m-bit sequence b₀, b₁, . . . , bₘ₋₂, bₘ₋₁, and the first bit transmitted or sequentially processed may be the leftmost bit b₀. The numeric representation of that sequence bₘ₋₁bₘ₋₂ . . . b₁b₀ has b₀ as the LSB and bₘ₋₁ as the most-significant bit (MSB). The m-bit sequence may be depicted as a binary, octal, or hexadecimal number.

Referring to FIG. 4, the preamble 402 may include, e.g., 32 bits that are transmitted over 8 μs. The 32 bits of the preamble 402 may be transmitted at the LEHS4 rate as seen above in Table 1. In certain aspects, the preamble 402 may be a fixed sequence of zeros. In certain aspects, the first two bits of the preamble 402 may be mapped to, e.g., 1·exp{j0}=1.

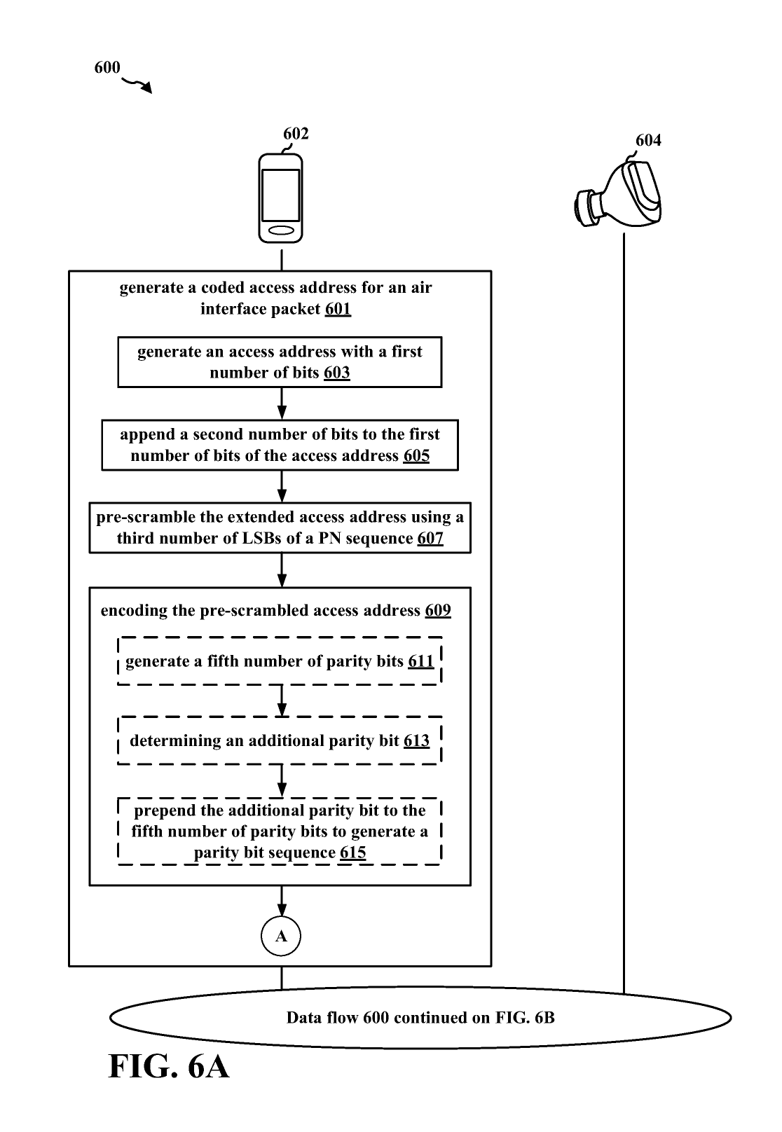

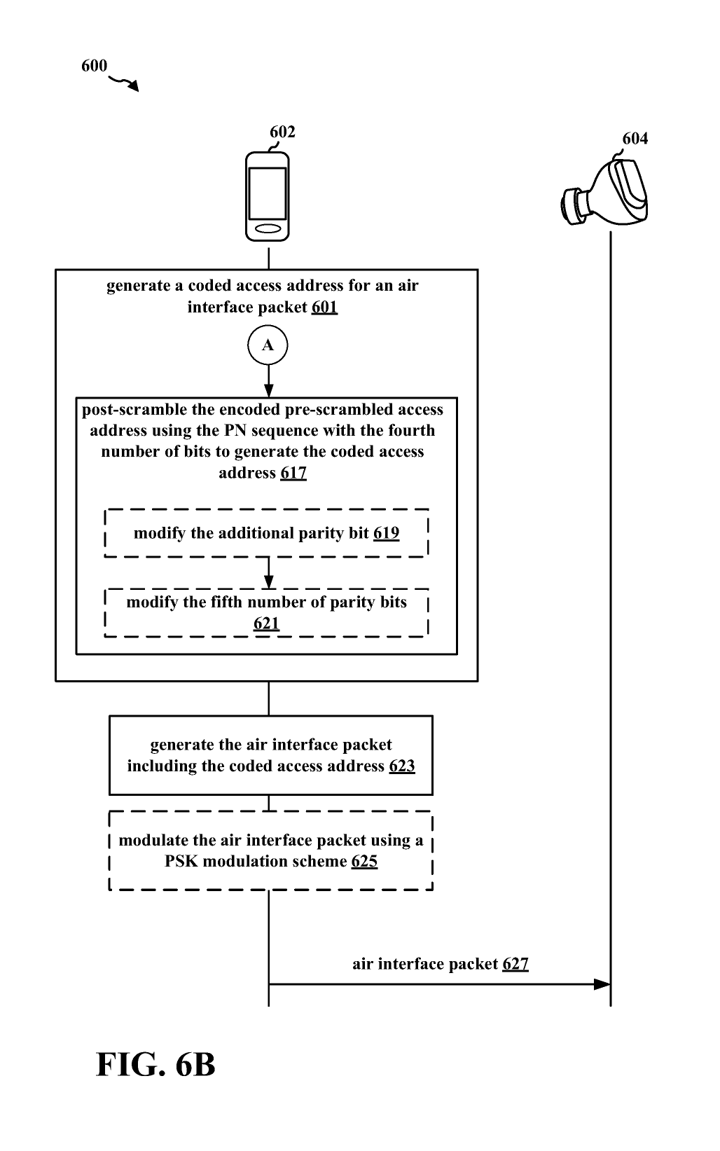

The coded access address 404 may include, e.g., 128 bits that are transmitted over 32 μs. The 128 bits of the coded access address 404 may be transmitted at the LEHS 4 rate as seen above in Table 1. Details associated with generating the coded access address 404 are discussed below with reference to FIGS. 6A and 6B.

The access code trailer 406 may include, e.g., 4 bits that are transmitted over 1 μs. The 4 bits of the access code trailer 406 may be transmitted at the LEHS4 rate as seen above in Table 1. The value of the access code trailer may be b₀, b₁, b₂, b₃, where b₀=0, b₁=0, b₂=1, and b₃=0. The access code trailer 406 may be used for the transition from detection of the coded access address 404 to the demodulation and decoding of the rate indicator 408. In certain configurations, the access code trailer 406 may enable a reduction in hardware complexity associated with the transition from detection of the coded access address 404 to the demodulation and decoding of the rate indicator 408.

The rate indicator 408 may include, e.g., 16 bits that are transmitted over 4 μs. The 16 bits of the rate indicator 408 may be transmitted at the LEHS4 rate. The rate indicator 408 may be one of five values that is associated with one of the five modes of operation, represented by 4 bits. As seen below in Table 5, four bits are encoded into 16 bits by inserting 6 zeros after the first 2 bits (b₀ b₁), and 6 zeros after the second 2 bits (b₂ b₃). The first bit of the rate indicator 408 that is sent over the air is b₀ (which is a different b₀ than the b₀ discussed above with reference to the access code trailer 406).

TABLE 5
Rate Indicator Field Definition

| | | Prior to Coding | After Coding |
|---|---|---|---|
| Name | Rate | b₀ b₁ b₂ b₃ | b₀ b₁ 0 0 0 0 0 0 b₂ b₃ 0 0 0 0 0 0 |
| LEHS2 | 2 Mbps | 0011 | 0 0 0 0 0 0 0 0 1 1 0 0 0 0 0 0 |
| LEHS3 | 3 Mbps | 0101 | 0 1 0 0 0 0 0 0 0 1 0 0 0 0 0 0 |
| LEHS4 | 4 Mbps | 1001 | 1 0 0 0 0 0 0 0 0 1 0 0 0 0 0 0 |
| LEHS5 | 5 Mbps | 0110 | 0 1 0 0 0 0 0 0 1 0 0 0 0 0 0 0 |
| LEHS6 | 6 Mbps | 1010 | 1 0 0 0 0 0 0 0 1 0 0 0 0 0 0 0 |

The header 410, payload 412 (including message integrity check (MIC) when enabled), CRC 414, and TERM 416 may all be modulated and/or transmitted using the rate indicated in the rate indicator 408 values shown above in Table 5. The number of bits in the header 410 and the payload 412 may depend on the mode of operation.

When the air interface packet 400 is an advertising packet, the header 410 may use the packet header format seen below in Table 6.

TABLE 6
Advertising Packet Header Format

| LSB | | | | | MSB |
|---|---|---|---|---|---|
| PDU Type | RFU | ChSel | TxAdd | RxAdd | Length |
| (4 bits) | (1 bit) | (1 bit) | (1 bit) | (1 bit) | (8 bits) |

As seen above in Table 6, the packet data unit (PDU) type may include 4 bits and indicate the air interface packet's type. The reserved for future use (RFU) portion may include 1 bit and may not have any particular use. The channel selection (ChSel) portion may have 1 bit and indicate the channel used for BLE communications. The TxAdd portion may include 1 bit and be used indicate the identifier of the transmitting device. The RxAdd portion may include 1 bit, and be used indicate the length of the subsequent data in the payload 412.

When the air interface packet 400 is a data packet, the header 410 may use the packet header format seen below in Table 7. Octets 0 and 1 in Table 7 may be the same as octets 0 and 1 used in traditional BLE. Octet 2 in Table 7 may include two additional MSBs for the length (extending the maximum payload length to 1023 octets) and has 6 bits reserved for future proprietary use (RFQU).

TABLE 7
Data Packet Header Format

| Octet 0 | | | | | | Octet 2 | |
|---|---|---|---|---|---|---|---|
| LSB | | | | MSB | Octet 1 | LSB | MSB |
| LLID | NESN | SN | MD | RFU | Length | LengthExt | RFQU |
| (2 bits) | (1 bit) | (1 bit) | (1 bit) | (3 bits) | (8 bits) | (2 bits) | (6 bits) |

As seen above in Table 7, the LL identification (LLID) may include 2 bits, and indicate the purpose and encoding of the payload. The next expected sequence number (NESN) may include 1 bit, and indicate the next expected sequence number in a series of transmission. The sequence number (SN) includes 1 bit, and indicates the SN of a particular transmission in the series of transmissions. The more data (MD) portion of the header may include 1 bit, and may indicate if additional transmissions will be sent. The length portion may include 8 bits, and may indicate the length of the payload. The LengthExt field extends the length portion from 8 bits to 10 bits. The RFQU field may include 6 bits, and may indicate whether the synthesizer on the receiver side remains on during the gap between the current reception and the subsequent transmission.

For calculation of the MIC, the message may be broken into two or more cipher-block-chaining blocks (e.g., B₀, B₁, . . . ). Cipher block chaining-message authentication code (CCM) mode is an authenticated encryption algorithm designed to provide both authentication and confidentiality during data transfer. The CCM terminology “Message authentication code (MAC)” is called the MIC in BT terminology. The Block B₀ format seen below in Table 8 may be used in counter mode block encryption to accommodate the longer (10-bit vs. 8-bit) length field.

TABLE 8
Block B₀ Format

| Offset | | Size | | |
|---|---|---|---|---|
| (octets) | Field | (octets) | Value | Description |
| 0 | Flags | 1 | 0x49 | As per the CCM specification |
| 1 | Nonce | 13 | Variable | Nonce0 shall have offset 1. |
| | | | | Nonce12 shall have offset 13. |
| 14 | Length | 1 | Variable | The most significant octet |
| | [MSO] | | (0x00 | (MSO) of the length of the |
| | | | for LE) | payload |
| 15 | Length | 1 | Variable | The least significant octet |
| | [LSO] | | | (LSO) of the length of the |
| | | | | payload |

In traditional BLE, the length of the MOS (Length[MSO]) is set to 0x00 based on an 8-bit length field. With LEHS BLE, since the length is now 10 bits, the Length[MSO] value depends on bits 0 and 1 of the ExtLength field in the length extension to the data packet header.

Two formats may be supported with Block B₁. The first format does not include the SUPP_INFO field as seen below in Table 9. The second format does include SUPP_INFO as seen below in Table 10. The first format of Block B₁ format is modified from traditional BLE in order to accommodate the longer (10-bit vs. 8-bit) length field and the extended data packet header. The second format of Block B₁ format is modified from traditional BLE in order to accommodate the longer (10-bit vs. 8-bit) length field, the extended data packet header, and the SUPP_INFO octet.

TABLE 9
Block B₁ Format (without SUPP_INFO)

| Offset | | Size | | |
|---|---|---|---|---|
| (octets) | Field | (octets) | Value | Description |
| 0 | AAD_Length[MSO] | 1 | 0x00 | The most significant octet of |
| | | | | the length of the additional |
| | | | | authenticated data |
| 1 | AAD_Length[LSO] | 1 | 0x02 (0x01 | The least significant octet of |
| | | | for LE) | the length of the additional |
| | | | | authenticated data |
| 2 | AAD | 1 | Variable | The data channel PDU |
| | | | | header's first octet with |
| | | | | NESN, SN and MD bits |
| | | | | masked to 0 |
| 3 | AAD_Proprietary | 1 | Variable | The data channel PDU |
| | (1^{st} octet of padding for LE) | | | header's third octet with |
| | | | | LengthExt and RFQU bits |
| | | | | masked to 0. |
| | | | | Note: if RFQU bits are |
| | | | | defined in the future some of |
| | | | | these bits may need to be |
| | | | | unmasked |
| 4 | Padding | 12 | 0x00, 0x00, | These octets are only used to |
| | | (13 for | 0x00, 0x00, | pad the block. They are not |
| | | LE) | 0x00, 0x00, | part of the packet and never |
| | | | 0x00, 0x00, | transmitted. |
| | | | 0x00, 0x00, | |
| | | | 0x00, 0x00, | |
| | | | 0x00, 0x00 | |

TABLE 10
Block B₁ Format (with SUPP_INFO)

| Offset | | Size | | |
|---|---|---|---|---|
| (octets) | Field | (octets) | Value | Description |
| 0 | AAD_Length[MSO] | 1 | 0x00 | The most significant octet of |
| | | | | the length of the additional |
| | | | | authenticated data |
| 1 | AAD_Length[LSO] | 1 | 0x03 (0x01 | The least significant octet of |
| | | | for LE) | the length of the additional |
| | | | | authenticated data |
| 2 | AAD | 1 | Variable | The data channel PDU |
| | | | | header's first octet with |
| | | | | NESN, SN and MD bits |
| | | | | masked to 0 |
| 3 | AAD_Proprietary | 1 | Variable | The data channel PDU |
| | (1^{st} octet of padding for LE) | | | header's third octet with |
| | | | | LengthExt and RFQU bits |
| | | | | masked to 0. |
| | | | | Note: if RFQU bits are |
| | | | | defined in the future some of |
| | | | | these bits may need to be |
| | | | | unmasked |
| 4 | SUPP_INFO | 1 | Variable | The SUPP_INFO field |
| 5 | Padding | 11 | 0x00, 0x00, | The octets are only used to |
| | | (13 for | 0x00, 0x00, | pad the block. The octects |
| | | LE) | 0x00, 0x00, | are not part of the packet |
| | | | 0x00, 0x00, | and never transmitted. |
| | | | 0x00, 0x00, | |
| | | | 0x00, 0x00, | |
| | | | 0x00 | |

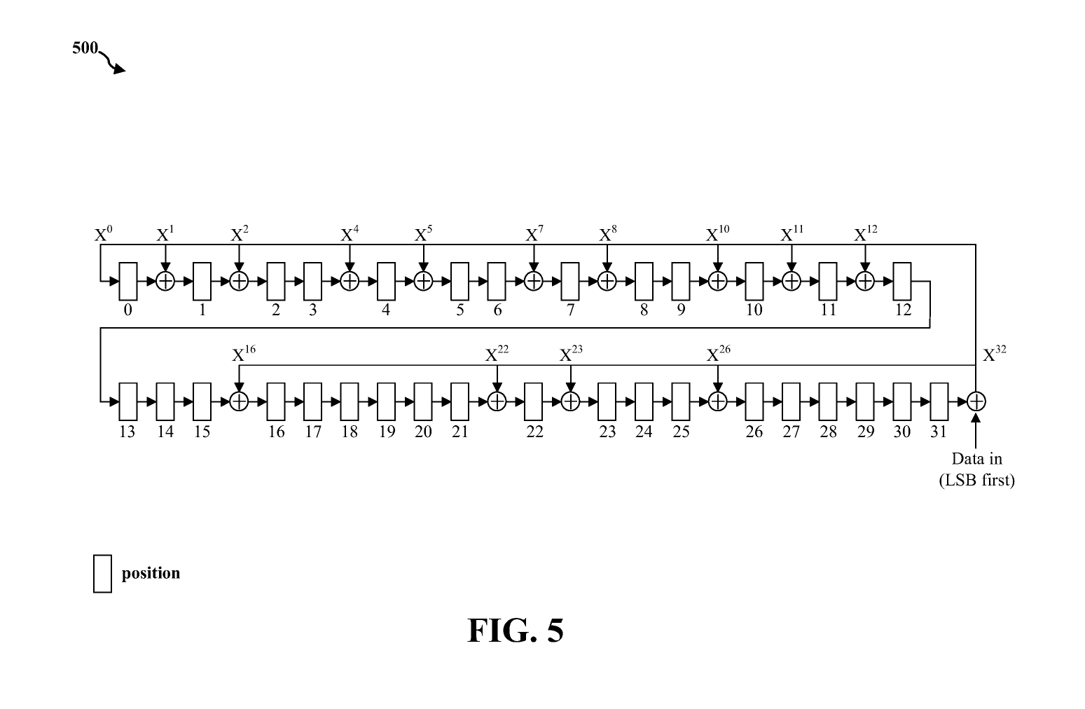

In certain aspects, the air interface packet 400 may use a 32-bit CRC 414 instead of the 24-bit CRC used in traditional BLE. The CRC 414 polynomial of the present disclosure may be x³²+x²⁶+x²³+x²²+x¹⁶+x¹²+x¹¹+x¹⁰+x⁸+x⁷+x⁵+x⁴+x²+x¹+x⁰. Additional details associated with determining and/or transmitting the CRC 414 are discussed below with reference to FIG. 5.

In certain other aspects, the header 410, the payload 412, and CRC 414 may be terminated (e.g., in the TERM 416) with T number of zeros. The T number of zeros may be determined such that if X=0, then T=m; otherwise, if X does not equal zero, then T=m−(P−X), where X=mod (N+m, P), m is the code memory, and P is the period. As seen below in Table 11, the values of P and m used in determining the T number of zeros may be based on the mode of operation. The supplemental portion 418 may be used to determine to an angle of arrival of the air interface packet 400.

TABLE 11
Calculation of Number of Padding Zeros in TERM

| Name | P (period) | m (memory) |
|---|---|---|
| LEHS2 | 1 | 4 |
| LEHS3 | 3 | 4 |
| LEHS4 | 2 | 0 |
| LEHS5 | 5 | 4 |
| LEHS6 | 3 | 0 |

Bit stream processing of the air interface packet 400 may use the same order as the order used in bit stream processing a traditional BLE air interface packets. When the uncoded LEHS modes are used, the payload bit processing may be performed as per FIG. 3.1 (Volume 6, Part B, Section 3) of Bluetooth 5.0. When the coded LEHS modes are used, the payload bit processing may be performed as per FIG. 3.2 (Volume 6, Part B, Section 3) of Bluetooth 5.0.

Whitening is a technique that may be used to reduce a direct current bias of data packets. The air interface packet 400 may be whitened using a 7-bit LFSR with polynomial x⁷+x⁴+x⁰. The LFSR may be initialized with the channel number placed in LFSR positions 0 through 5, and position 6 is set to ‘1’ to ensure that the LFSR is not initialized to zero. Whitening may begin with the first bit of the header 410. In certain aspects, the preamble 402, coded access address 404, and rate indicator 408 may not be whitened.

The preamble 402, the coded access address 404, the access code trailer 406, and the rate indicator 408 may be modulated using π/4-DQPSK. During rate indicator zero insertion (e.g., insertion of two sets of 6 bits), the LEHS PHY 322 may switch to DQPSK, e.g., sₖ=sₖ₋₁ exp{j(ϕₖ)} (as opposed to π/4-DQPSK, i.e., sₖ=sₖ₋₁ exp{j(ϕₖ+π/4)}). By switching to DQPSK, two sets of repeated symbols may be generated.

When a modulation scheme is used with coding (e.g., LEHS2, LEHS3, or LEHS5), a field indicating the number of errors in the received packet may be available for a processor (e.g., processor(s) 202 in FIG. 2) to read in order to help estimate the BER associated with the air interface packet 400.

FIG. 5 is a diagram illustrating a LFSR 500 used to generate a CRC for an air interface packet in accordance with certain aspects of the disclosure. For example, the LFSR 500 may be used to generate the CRC 414 in the air interface packet 400 illustrated in FIG. 4.

As previously mentioned, an air interface packet of the present disclosure may use a 32-bit CRC instead of the 24-bit CRC used in traditional BLE. The CRC polynomial may be x³²+x²⁶+x²³+x²²+x¹⁶+x¹²+x¹¹+x¹⁰+x⁸+x⁷+x⁵+x⁴+x²+x¹+x⁰. For each data channel PDU, the LFSR 500 may be preset with a CRC initialization value (e.g., CRCInit value). The LL connection may be initialized using the CRCInit value, and the LL CONNECT_IND PDU may be extended with one additional octet=0x00. Position 0 may be set as the LSB, and position 31 may be set as the MSB of the initialization value. The CRC may be transmitted such that the MSB is transmitted first, e.g., from position 31 to position 0.

FIGS. 6A and 6B illustrate a data flow 600 that may be used to generate an air interface packet in accordance with certain aspects of the disclosure. The air interface packet may be generated by a first device 602, and transmitted to a second device 604. In certain aspects, the first device 602 and the second device 604 may be BLE enabled devices. The first device 602 may correspond to, e.g., central device 102, peripheral device 104, 106, 108, 110, 112, 114, 200, the apparatus 902/902′. The second device 604 may correspond to, e.g., central device 102, peripheral device 104, 106, 108, 110, 112, 114, 200, the second device 950. In FIGS. 6A and 6B, optional operations are indicated with dashed lines.

Referring to FIG. 6A, the first device 602 may generate (at 601) a coded access address for an air interface packet. For example, the coded access address generated by the first device may correspond to the coded access address 404 seen in FIG. 4.

In certain aspects, the first device 602 may generate the coded access address by generating (at 603) an access address with a first number of bits (e.g., 32 bits). For example, the access address may be a 32-bit random access address, e.g., a₀, a₁, . . . a₃₀, a₃₁.

In certain other aspects, the first device 602 may generate the coded access address by appending (at 605) a second number of bits (e.g., 4 bits) to the first number of bits to generate an extended access address. For example, the first device 602 may append 4-bits (e.g., a₃₂, a₃₃, a₃₄, a₃₅) such that a₃₁, a₃₂, a₃₃, a₃₄, a₃₅ form a 5-bit Barker code (e.g., 0,0,0,1,0 or 1,1,1,0,1). In other words, if a₃₁=0, then a₃₂, a₃₃, a₃₄, a₃₅=0,0,1,0. If a₃₁=1, then a₃₂, a₃₃, a₃₄, a₃₅=1,1,0,1. The structure of the extended access address sequence may be [a₀, a₁, . . . a₃₀, a₃₁][a₃₂, a₃₃, a₃₄, a₃₅].

In certain other aspects, the first device 602 may generate the coded access address by pre-scrambling (at 607) the extended access address (e.g., [a₀, a₁, . . . a₃₀, a₃₁][a₃₂, a₃₃, a₃₄, a₃₅]) using a third number of LSBs (e.g., 36 LSBs) of a PN sequence to generate a pre-scrambled access address. In one aspect, the PN sequence may include a fourth number of bits (e.g., 128 bits). The first device 602 may pre-scramble (at 607) the extended access address with 36 LSBs of a 128-bit PN sequence. In certain aspects, the same 128-bit PN sequence (e.g., 0x36283B4F09BA2359CCBD4AB8FBF92181) may be used for both pre-scrambling (at 607) and post-scrambling (at 617). However, the pre-scrambling may only use the 36 LSBs (e.g., 0x8FBF92181) in the PN sequence.

The PN sequence 0x36283B4F09BA2359CCBD4AB8FBF92181 may be determined by appending bit 0 to a 127-bit m-sequence (i.e., MSB is 0; remaining 127 bits form the m-sequence). The generator polynomial g(x)=+x⁶+x⁵+x⁴+x³+x²+1 and initial seed 0x01 may be used to generate the m-sequence. When the m-sequence is constant, the first device 602 may not need to implement the generator polynomial to determine the m-sequence.

Given a 128-bit PN-sequence of p₀, p₁, . . . p₁₂₆, p₁₂₇, the pre-scrambled access address may be determined such that ãₖ=aₖ⊕p₃₅₋ₖ, ∀k=0, 1, . . . 35 where ⊕ is the XOR operation. The structure of the pre-scrambled access address generated (at 607) may be, e.g., [ã₀, ã₁, . . . ã₃₀, ã₃₁][ã₃₂, . . . ã₃₅].

In certain aspects, the first device 602 may generate the coded access address by encoding (at 609) the pre-scrambled access address such that the encoded pre-scrambled access address includes the same number of bits as the fourth number of bits in the PN sequence. For example, the encoded pre-scrambled access address may include 128 bits.

In certain aspects, the first device 602 may encode (at 611) the pre-scrambled access address such that an encoded pre-scrambled access address includes fewer than the fourth number of bits in the PN sequence to generate a fifth number of parity bits (e.g., 91 parity bits). For example, the pre-scrambled access address sequence may be encoded (at 611) to 127 bits, to generate 91 parity bits c₀, c₁, . . . c₈₉, c₉₀.

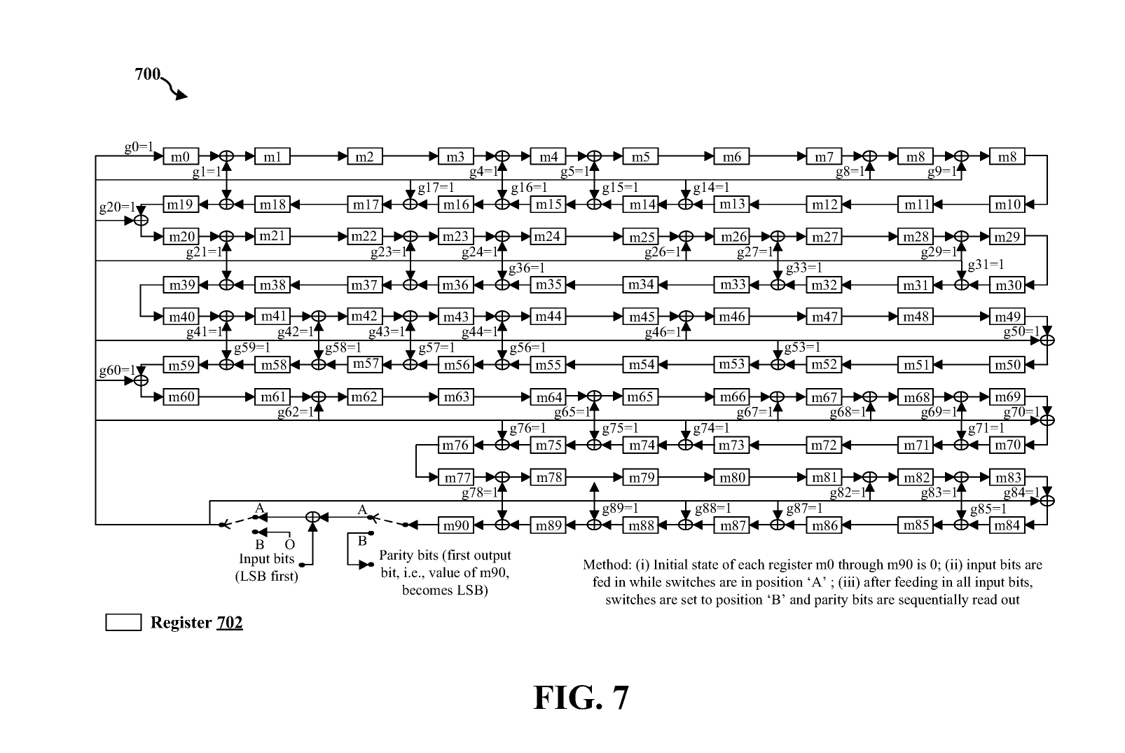

Encoding the pre-scrambled access address sequence may be based on the generator polynomial 2736134764574442741125554741463 (octal), which is the reversed form of generator polynomial 3146074666522075044764574721735 (octal) corresponding to the Bose-Chaudhuri-Hocquenghem (BCH) code (127,36). One example of an encoder structure that may be used by the first device 602 to encode (at 611) the pre-scrambled access address is illustrated in FIG. 7.

In certain aspects, the first device 602 may determine (at 613) an additional parity bit. For example, an additional parity bit b may be determined (at 613) so that the 128-bit codeword produced by prepending (at 615) parity bit sequence b, c₀, c₁, . . . c₈₉, c₉₀ to the scrambled access address bit sequence ã₀, ã₁, . . . ã₃₅, ã₃₆ has even parity. The structure of the encoded pre-scrambled access address may be, e.g., [b][c₀, c₁, . . . c₈₉, c₉₀][ã₀, ã₁, . . . ã₃₀, ã₃₁][ã₃₂, . . . ã₃₅].

Referring to FIG. 6B, the first device 602 may generate the coded access address by post-scrambling (at 617) the encoded pre-scrambled access address using the PN sequence to generate the coded access address. In certain aspects, the coded access address may include the same number of bits as the fourth number of bits in the PN sequence. As mentioned above, the PN-sequence p₀, p₁, . . . , p₁₂₆, p₁₂₇ used for pre-scrambling (at 607) may also be used for post-scrambling (at 617) to generate the coded access address.

For example, the first device 602 may modify (at 619) the additional parity bit b such that \tilde{b}=b⊕p₁₂₇, where \tilde{b} is the modified additional parity bit. In certain other aspects, the first device 602 may modify (at 621) the fifth number of parity bits. For example, the first device 602 may modify the remaining parity bits c₀, c₁, . . . c₈₉, c₉₀ to \tilde{c}₀, \tilde{c}₁, . . . \tilde{c}₉₀, where \tilde{c}ₖ=cₖ⊕p₁₂₆₋ₖ, ∀k=0, 1, . . . 90. Post-scrambling (at 617) ãₖ⊕p₃₅₋ₖ, ∀k=0, 1, . . . 35 yields a₀, a₁, . . . a₃₅.

The 128-bit sequence generated after post-scrambling (at 617) may be the coded access address. The uncoded access address may occupy bit positions 92 through 123. The structure of the coded access address may be, e.g., [\tilde{b}][\tilde{c}₀, \tilde{c}₁, . . . \tilde{c}₉₀][a₀, a₁, . . . a₃₀, a₃₁][a₃₂, . . . a₃₅].

By expanding a 32-bit access address to 128 bits, a transmission of the access address is repeated four times, which allows for a higher level of sensitivity correlation than by transmitting the access address once (e.g., as in traditional BLE).

The first device 602 may generate (at 623) the air interface packet including the coded access address. In certain aspects, the air interface packet may include a preamble, the coded access address described above, an access code trailer, a rate indicator, a header, a payload, a CRC, a termination portion, and a supplemental portion. The air interface packet may be generated using the techniques described above with reference to FIGS. 3 and 4.

In certain aspects, the first device 602 may modulate (at 625) the air interface packet using a PSK modulation scheme. For example, the first device 602 may modulate the air interface packet using the PSK modulation schemes discussed above with reference to FIGS. 3 and 4.

In certain other aspects, the first device 602 may transmit (at 627) the air packet interface to the second device 604. For example, the first device 602 may transmit the air interface packet to the second device 604 using the data rates and/or modulation schemes discussed above with reference to FIGS. 3 and 4.

Although techniques for generating a 128-bit coded access address are described above in FIGS. 6A and 6B, a coded access address may be generated that includes more than 128 bits without departing from the present disclosure.

FIG. 7 is a diagram illustrating an encoder 700 that may be used to encode a pre-scrambled access address sequence and determine parity bits in accordance with certain aspects of the disclosure. The encoder 700 may be located in, e.g., e.g., central device 102, peripheral device 104, 106, 108, 110, 112, 114, device 200, first device 602, the apparatus 902/902′. The encoder 700 may be used to, e.g., encode a pre-scrambled access address sequence and determine parity bits, as described above with reference to 611 in FIG. 6.

Referring to FIG. 7, the initial state of each of the plurality of registers 702 (e.g., m0, m1, m2, . . . m90) is 0. While the switches are in position A, input bits may be fed into the encoder 700 such that the LSB is fed in first. After feeding in all of the input bits, the switches are set to position B, and the parity bits are sequentially read out.

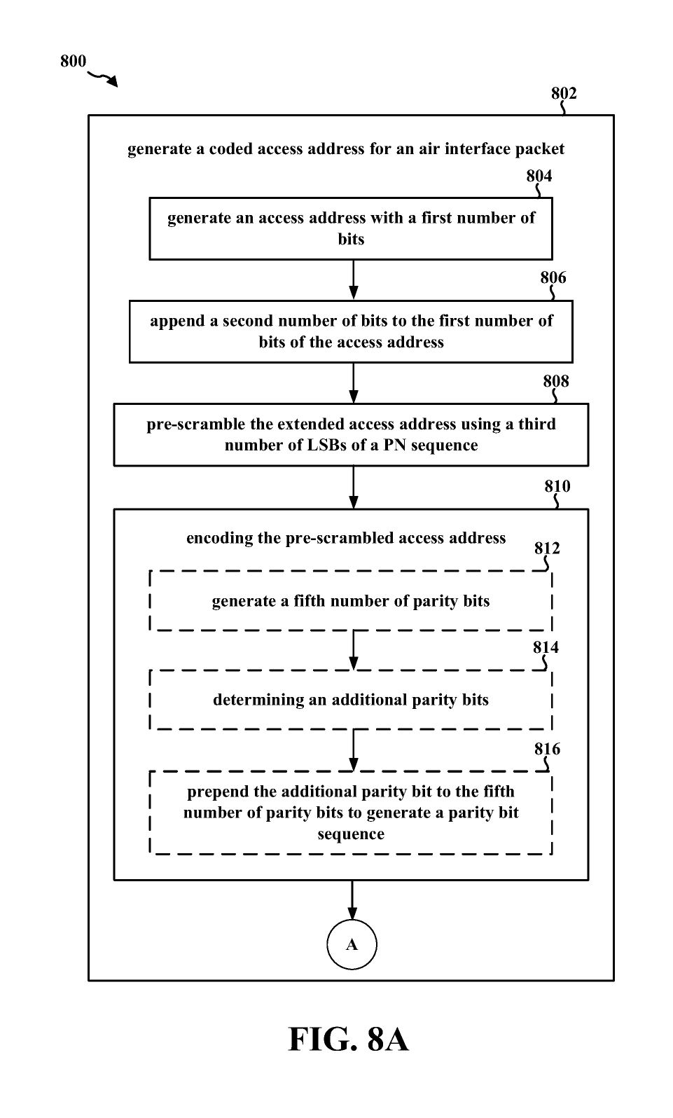

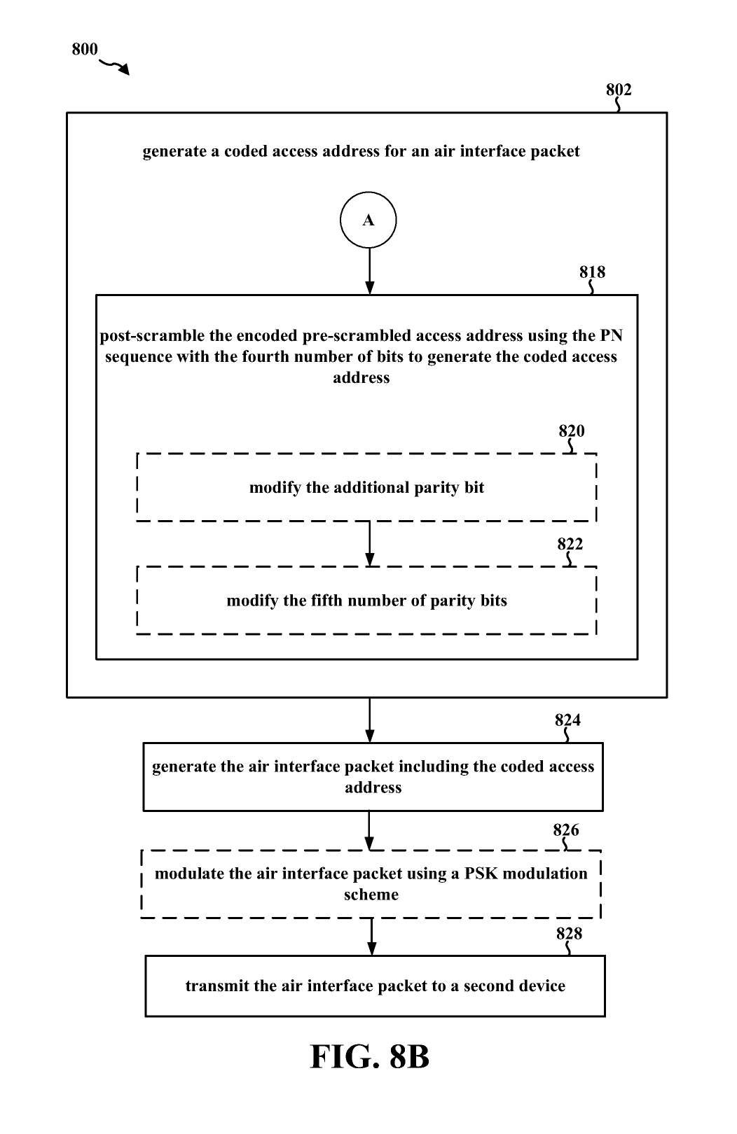

FIGS. 8A and 8B are a flowchart 800 of a method of wireless communication. The method may be performed by a first device (e.g., central device 102, peripheral device 104, 106, 108, 110, 112, 114, device 200, first device 602, the apparatus 902/902′) in communication with a second device (e.g., central device 102, peripheral device 104, 106, 108, 110, 112, 114, device 200, second device 604, 950). In FIGS. 8A and 8B, optional operations are indicated with dashed lines.

Referring to FIG. 8A, at 802, the first device may generate a coded access address for an air interface packet. For example, referring to FIG. 6A, the first device 602 may generate (at 601) a coded access address for an air interface packet. For example, the coded access address generated by the first device may correspond to the coded access address 404 seen in FIG. 4.

At 804, the first device may generate the coded access address by generating an access address with a first number of bits. For example, referring to FIG. 6A, the first device 602 may generate the coded access address by generating (at 603) an access address with a first number of bits (e.g., 32 bits). For example, the access address may be a 32-bit random access address, e.g., a₀, a₁, . . . a₃₀, a₃₁.

At 806, the first device may generate the coded access address by appending a second number of bits to the first number of bits of the access address to generate an extended access address. For example, referring to FIG. 6A, the first device 602 may generate the coded access address by appending (at 605) a second number of bits (e.g., 4 bits) to the first number of bits of the access address to generate an extended access address. For example, the first device 602 may append 4-bits (e.g., a₃₂, a₃₃, a₃₄, a₃₅) such that a₃₁, a₃₂, a₃₃, a₃₄, a₃₅ form a 5-bit Barker code (e.g., 0,0,0,1,0 or 1,1,1,0,1). In other words, if a₃₁=0, then a₃₂, a₃₃, a₃₄, a₃₅=0,0,1,0. If a₃₁=1, then a₃₂, a₃₃, a₃₄, a₃₅=1,1,0,1. The structure of the extended access address sequence may be [a₀, a₁, . . . a₃₀, a₃₁][a₃₂, a₃₃, a₃₄, a₃₅].

At 808, the first device may generate the coded access address by pre-scrambling the extended access address using a third number of LSBs of a PN sequence to generate a pre-scrambled access address. In certain aspects, the PN sequence may include a fourth number of bits. In certain other aspects, the fourth number of bits may be at least 128 bits. For example, referring to FIG. 6A, the first device 602 may generate the coded access address by pre-scrambling (at 607) the extended access address (e.g., [a₀, a₁, . . . a₃₀, a₃₁][a₃₂, a₃₃, a₃₄, a₃₅]) using a third number of LSBs of a PN sequence to generate a pre-scrambled access address. In one aspect, the PN sequence may include a fourth number of bits (e.g., 128 bits). For example, the first device 602 may pre-scramble (at 607) the extended access address with 36 LSBs (e.g., the third number of LSBs) of a 128-bit PN sequence. In certain aspects, the same 128-bit PN sequence 0x36283B4F09BA2359CCBD4AB8FBF92181 may be used for both pre-scrambling (at 607) and post-scrambling (at 617). However, the pre-scrambling may only use the 36 LSBs 0x8FBF92181 in the PN sequence. The PN sequence 0x36283B4F09BA2359CCBD4AB8FBF92181 may be determined by appending bit 0 to a 127-bit m-sequence (i.e., MSB is 0; remaining 127 bits form the m-sequence). The generator polynomial g(x)=x⁷+x⁶+x⁵+x⁴+x³+x²+1 and initial seed 0x01 may be used to generate the m-sequence. When the m-sequence is constant, the first device 602 may not need to implement the generator to determine the m-sequence. Given a 128-bit PN-sequence of p₀, p₁, . . . p₁₂₆, p₁₂₇, the pre-scrambled access address may be determined such that ãₖ=aₖ⊕p₃₅₋ₖ, ∀k=0, 1, . . . 35 where ⊕ is the XOR operation. The structure of the pre-scrambled access address generated (at 607) by the first device 602 may be, e.g., [ã₀, ã₁, . . . ã₃₀, ã₃₁][ã₃₂, . . . ã₃₅].

At 810, the first device may generate the coded access address by encoding the pre-scrambled access address such that the encoded pre-scrambled access address includes a same number of bits as the fourth number of bits in the PN sequence. For example, referring to FIG. 6A, the first device 602 may generate the coded access address by encoding (at 609) the pre-scrambled access address such that the encoded pre-scrambled access address includes a same number of bits as the fourth number of bits in the PN sequence.

At 812, the first device may encode the pre-scrambled access address by encoding the pre-scrambled access address such that an encoded pre-scrambled access address includes fewer than the fourth number of bits in the PN sequence to generate a fifth number of parity bits. For example, referring to FIG. 6A, the first device 602 may encode (at 611) the pre-scrambled access address such that an encoded pre-scrambled access address includes fewer than the fourth number of bits in the PN sequence to generate a fifth number of parity bits (e.g., 91 parity bits). For example, the pre-scrambled access address sequence may be encoded (at 611) to 127 bits, to determine 91 parity bits c₀, c₁, . . . c₈₉, c₉₀. The code used to encode the pre-scrambled access address sequence may be based on the generator polynomial 2736134764574442741125554741463 (octal), which is the reversed form of generator polynomial 3146074666522075044764574721735 (octal) corresponding to the BHC code (127,36). The encoder structure that may be used by the first device 602 to encode (at 611) the pre-scrambled access address is illustrated in FIG. 7.

At 814, the first device may encode the pre-scrambled access address by determining an additional parity bit. For example, referring to FIG. 6A, the first device 602 may determine (at 613) an additional parity bit b.

At 816, the first device may encode the pre-scrambled access address by prepending the additional parity bit to the fifth number of parity bits to generate a parity bit sequence. In one aspect, the parity bit sequence may include the same number of bits as the fourth number of bits in the PN sequence. For example, referring to FIG. 6A, an additional parity bit b may be determined (at 613) so that the 128-bit codeword produced by prepending (at 615) parity bit sequence b, c₀, c₁, . . . c₈₉, c₉₀ to scrambled access address bit sequence ã₀, ã₁, . . . ã₃₅, ã₃₆ has even parity. The structure of the encoded pre-scrambled access address may be, e.g., [b][c₀, c₁, . . . c₈₉, c₉₀][ã₀, ã₁, . . . ã₃₀, ã₃₁][ã₃₂, . . . ã₃₅].

Referring to FIG. 8B, at 818, the first device may generate the coded access address by post-scrambling the encoded pre-scrambled access address using the PN sequence with the fourth number of bits to generate the coded access address. In one aspect, the coded access address may include the same number of bits as the fourth number of bits in the PN sequence. For example, referring to FIG. 6B, the first device 602 may generate the coded access address by post-scrambling (at 617) the encoded pre-scrambled access address using the PN sequence with the fourth number of bits to generate the coded access address. In certain aspects, the coded access address may include the same number of bits as the fourth number of bits in the PN sequence. As mentioned above, the PN-sequence p₀, p₁, . . . , p₁₂₆, p₁₂₇ used for pre-scrambling (at 607) may also be used for post-scrambling (617) to generate the coded access address.

At 820, the first device may post-scramble the encoded pre-scrambled access address using the PN sequence with the fourth number of bits by modifying the additional parity bit. For example, referring to FIG. 6B, the first device 602 may modify (at 619) the additional parity bit b such that \tilde{b}=b⊕p₁₂₇, where \tilde{b} is the modified additional parity bit.

At 822, the first device may post-scramble the encoded pre-scrambled access address using the PN sequence with the fourth number of bits by modifying the fifth number of parity bits. In certain aspects, the coded access address may include the modified additional parity bit, the modified fifth number of parity bits, and the extended access address. For example, referring to FIG. 6B, the first device 602 may modify (at 621) the fifth number of parity bits. For example, the first device 602 may modify the remaining parity bits c₀, c₁, . . . c₈₉, c₉₀ to \tilde{c}₀, \tilde{c}₁, . . . \tilde{c}₉₀, where \tilde{c}ₖ=cₖ⊕p₁₂₆₋ₖ, ∀k=0, 1, . . . 90. Post-scrambling (at 617) ãₖ⊕p₃₅₋ₖ, ∀k=0, 1, . . . 35 yields a₀, a₁, . . . a₃₅. The 128-bit sequence generated after post-scrambling (at 617) is the coded access address. The uncoded access address may occupy bit positions 92 through 123. The structure of the coded access address may be, e.g., [\tilde{b}][\tilde{c}₀, \tilde{c}₁, . . . \tilde{c}₉₀][a₀, a₁, . . . a₃₀, a₃₁][a₃₂, . . . a₃₅].

At 824, the first device may generate the air interface packet including the coded access address. In one aspect, the air interface packet may also include a preamble, an access code trailer, a rate indicator, a header, a payload, a CRC, a termination portion, and a supplemental portion. In other aspects, the rate indicator may indicate a modulation scheme of a plurality of modulation schemes that is used to modulate the header and the payload. For example, referring to FIG. 6B, first device 602 may generate (at 623) the air interface packet including the coded access address. In certain aspects, the air interface packet may include a preamble, the coded access address described above, an access code trailer, a rate indicator, a header, a payload, a CRC, a termination portion, and a supplemental portion. The air interface packet may be generated using the techniques described above with reference to FIGS. 3 and 4.

At 826, the first device may modulate the air interface packet using a PSK modulation scheme. For example, referring to FIG. 6B, the first device 602 may modulate (at 625) the air interface packet using a PSK modulation scheme. For example, the first device 602 may modulate the air interface packet to the second device 604 using the PSK modulation schemes discussed above with reference to FIGS. 3 and 4.

At 828, the first device may transmit the air interface packet using short-range communications to a second device. For example, referring to FIG. 6B, the first device 602 may transmit (at 627) the air interface packet to the second device 604 using the data rates and/or modulation schemes discussed above with reference to FIGS. 3 and 4.

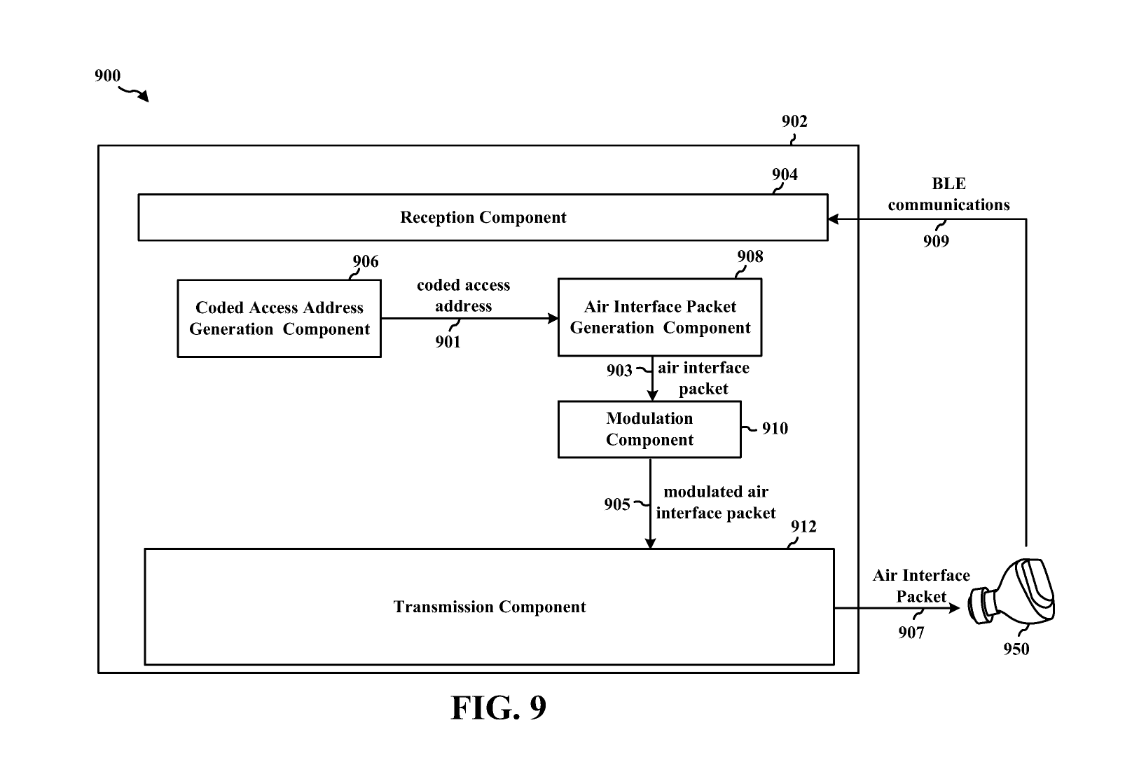

FIG. 9 is a conceptual data flow diagram 900 illustrating the data flow between different means/components in an exemplary apparatus 902. The apparatus may be a first device (e.g., central device 102, peripheral device 104, 106, 108, 110, 112, 114, device 200, first device 602, the apparatus 902′) in communication with a second device 950 (e.g., central device 102, peripheral device 104, 106, 108, 110, 112, 114, device 200, second device 604). The apparatus may include a reception component 904, a coded access address generation component 906, an air interface packet generation component 908, a modulation component 910, and a transmission component 912.

The coded access address generation component 906 may be configured to generate a coded access address for an air interface packet. In certain aspects, the coded access address generation component 906 may be configured to generate the coded access address by generating an access address with a first number of bits. In certain other aspects, the coded access address generation component 906 may be configured to generate the coded access address by appending a second number of bits to the first number of bits of the access address to generate an extended access address. In certain other aspects, the coded access address generation component 906 may be configured to generate the coded access address by pre-scrambling the extended access address using a third number of LSBs of a PN sequence to generate a pre-scrambled access address. In certain aspects, the PN sequence may include a fourth number of bits. In certain other aspects, the fourth number of bits may be at least 128 bits. In certain other aspects, the coded access address generation component 906 may be configured to generate the coded access address by encoding the pre-scrambled access address such that the encoded pre-scrambled access address includes a same number of bits as the fourth number of bits in the PN sequence. In certain other aspects, the coded access address generation component 906 may be configured to encode the pre-scrambled access address by encoding the pre-scrambled access address such that an encoded pre-scrambled access address includes fewer than the fourth number of bits in the PN sequence to generate a fifth number of parity bits. In certain other aspects, the coded access address generation component 906 may be configured to encode the pre-scrambled access address by determining an additional parity bit. In certain other aspects, the coded access address generation component 906 may be configured to encode the pre-scrambled access address by prepending the additional parity bit to the fifth number of parity bits to generate a parity bit sequence. In one aspect, the parity bit sequence may include the same number of bits as the fourth number of bits in the PN sequence. In certain other aspects, the coded access address generation component 906 may be configured to generate the coded access address by post-scrambling the encoded pre-scrambled access address using the PN sequence with the fourth number of bits to generate the coded access address. In one aspect, the coded access address may include the same number of bits as the fourth number of bits in the PN sequence. In certain other aspects, the coded access address generation component 906 may be configured to post-scramble the encoded pre-scrambled access address using the PN sequence with the fourth number of bits by modifying the additional parity bit. In certain other aspects, the coded access address generation component 906 may be configured to post-scramble the encoded pre-scrambled access address using the PN sequence with the fourth number of bits by modifying the fifth number of parity bits. In certain aspects, the coded access address may include the modified additional parity bit, the modified fifth number of parity bits, and the extended access address. In certain other aspects, the coded access address generation component 906 may be configured to send a signal 901 associated with the coded access address to the air interface packet generation component 908.

The air interface packet generation component 908 may be configured to generate the air interface packet including the coded access address. In one aspect, the air interface packet may also include a preamble, an access code trailer, a rate indicator, a header, a payload, a CRC, a termination portion, and a supplemental portion. In other aspects, rate indicator may indicate a modulation scheme of a plurality of modulation schemes that is used to modulate the header and the payload. The air interface packet generation component 908 may be configured to send a signal 903 associated with the air interface packet to the modulation component 910.

The modulation component 910 may be configured to modulate the air interface packet using a PSK modulation scheme (e.g., as described above with reference to FIGS. 3 and 4). The modulation component 910 may be configured to send a signal 905 associated with the modulated air interface packet to the transmission component 912.

The transmission component 912 may be configured to transmit the air interface packet 907 using short-range communications (e.g., BLE communications) to the second device 950.

The reception component 904 may be configured to receive BLE communications 909 from the second device.

The apparatus may include additional components that perform each of the blocks of the algorithm in the aforementioned flowcharts of FIGS. 8A and 8B. As such, each block in the aforementioned flowcharts of FIGS. 8A and 8B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

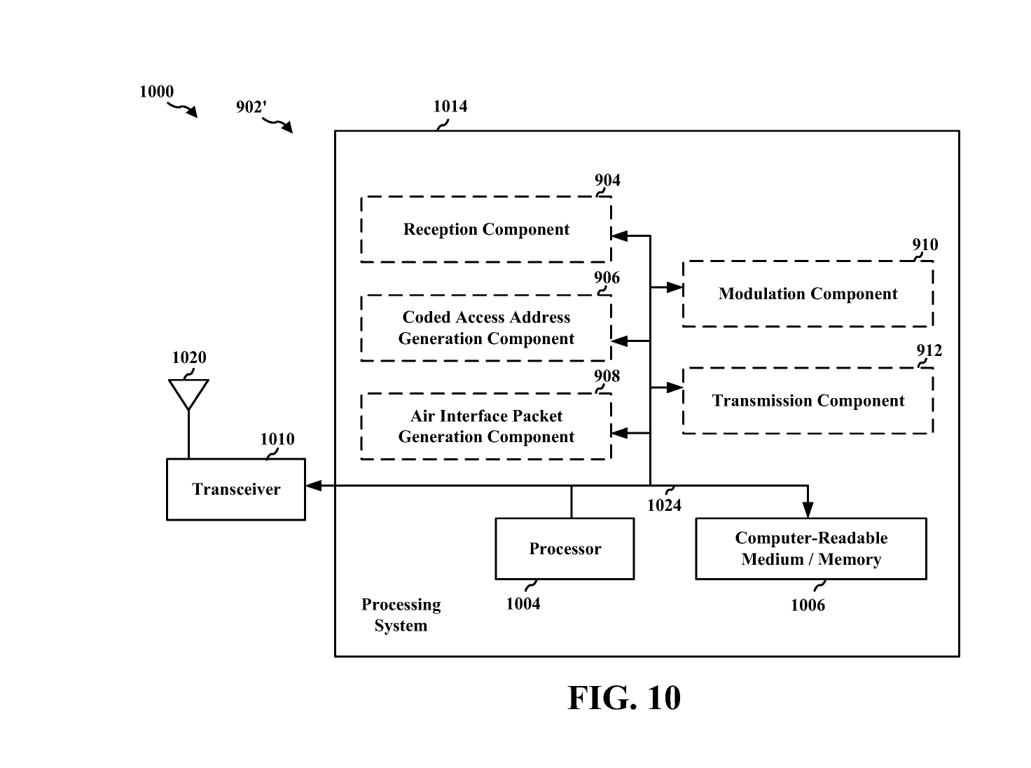

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904, 906, 908, 910, 912 and the computer-readable medium/memory 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014, specifically the reception component 904. In addition, the transceiver 1010 receives information from the processing system 1014, specifically the transmission component 912, and based on the received information, generates a signal to be applied to the one or more antennas 1020. The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 904, 906, 908, 910, 912. The components may be software components running in the processor 1004, resident/stored in the computer readable medium/memory 1006, one or more hardware components coupled to the processor 1004, or some combination thereof.

In one configuration, the apparatus 902/902′ for wireless communication includes means for generating a coded access address for an air interface packet. In one aspect, the means for generating the coded access address may be configured to generate an access address with a first number of bits. In other aspects, the means for generating the coded access address may be configured to append a second number of bits to the first number of bits of the access address to generate an extended access address. In other aspects, the means for generating the coded access address may be configured to pre-scramble the extended access address using a third number of LSBs of a PN sequence to generate a pre-scrambled access address. In certain aspects, the PN sequence may include a fourth number of bits. In certain other aspects, the fourth number of bits may be at least 128 bits. In other aspects, the means for generating the coded access address may be configured to encode the pre-scrambled access address such that the encoded pre-scrambled access address includes a same number of bits as the fourth number of bits in the PN sequence. In other aspects, the means for generating the coded access address may be configured to encode the pre-scrambled access address such that an encoded pre-scrambled access address includes fewer than the fourth number of bits in the PN sequence to generate a fifth number of parity bits. In other aspects, the means for generating the coded access address may be configured to determine an additional parity bit. In other aspects, the means for generating the coded access address may be configured to prepend the additional parity bit to the fifth number of parity bits to generate a parity bit sequence. In one aspect, the parity bit sequence may include the same number of bits as the fourth number of bits in the PN sequence. In other aspects, the means for generating the coded access address may be configured to post-scramble the encoded pre-scrambled access address using the PN sequence with the fourth number of bits to generate the coded access address. In one aspect, the coded access address may include the same number of bits as the fourth number of bits in the PN sequence. In one aspect, the means for generating the coded access address may be configured to modify the additional parity bit. In one aspect, the means for generating the coded access address may be configured to modify the fifth number of parity bits. In certain aspects, the coded access address may include the modified additional parity bit, the modified fifth number of parity bits, and the extended access address. In one configuration, the apparatus 902/902′ for wireless communication includes means for generating the air interface packet including the coded access address. In certain aspects, the air interface packet may include a preamble, the coded access address described above, an access code trailer, a rate indicator, a header, a payload, a CRC, a termination portion, and a supplemental portion. In one configuration, the apparatus 902/902′ for wireless communication includes means for transmitting the air interface packet using short-range communications to a second device. In one configuration, the apparatus 902/902′ for wireless communication includes means for modulating the air interface packet using a PSK modulation scheme. The aforementioned means may be one or more of the aforementioned processor(s) 202, short-range communications controller 252, and/or radio 230 in FIG. 2, components of the apparatus 902 and/or the processing system 1014 of the apparatus 902′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication for a first device, comprising:
generating a coded access address for an air interface packet by:
generating an access address with a first number of bits;
appending a second number of bits to the first number of bits of the access address to generate an extended access address;
pre-scrambling the extended access address using a third number of least significant bits (LSBs) of a pseudo-noise (PN) sequence to generate a pre-scrambled access address, the PN sequence including a fourth number of bits;
encoding the pre-scrambled access address such that the encoded pre-scrambled access address includes a same number of bits as the fourth number of bits in the PN sequence; and
post-scrambling the encoded pre-scrambled access address using the PN sequence with the fourth number of bits to generate the coded access address, the coded access address including the same number of bits as the fourth number of bits in the PN sequence;
generating the air interface packet including the coded access address; and
transmitting the air interface packet using short-range communications to a second device.

2. The method of claim 1, wherein the encoding the pre-scrambled access address such that the pre-scrambled access address includes the same number of bits as the fourth number of bits in the PN sequence comprises:
encoding the pre-scrambled access address such that the encoded pre-scrambled access address includes fewer than the fourth number of bits in the PN sequence to generate a fifth number of parity bits;
determining an additional parity bit; and
prepending the additional parity bit to the fifth number of parity bits to generate a parity bit sequence.

3. The method of claim 2, wherein the parity bit sequence includes the same number of bits as the fourth number of bits in the PN sequence.

4. The method of claim 2, wherein the post-scrambling the encoded pre-scrambled access address using the PN sequence with the fourth number of bits comprises:
modifying the additional parity bit; and
modifying the fifth number of parity bits.

5. The method of claim 4, wherein the coded access address includes the modified additional parity bit, the modified fifth number of parity bits, and the extended access address.

6. The method of claim 1, wherein the fourth number of bits is at least one-hundred and twenty-eight bits.

7. The method of claim 1, wherein the air interface packet further comprises a preamble, an access code trailer, a rate indicator, a header, a payload, a cyclic redundancy check (CRC), a termination portion, and a supplemental portion.

8. The method of claim 7, wherein the rate indicator indicates a modulation scheme used for modulating one or more of the header, the payload, and the CRC.

9. The method of claim 1, further comprising:
modulating the air interface packet using a phase shift keying (PSK) modulation scheme.

10. An apparatus for wireless communication for a first device, comprising:
a memory; and
at least one processor coupled to the memory and configured to:
generate a coded access address for an air interface packet by:
generating an access address with a first number of bits;
appending a second number of bits to the first number of bits of the access address to generate an extended access address;
pre-scrambling the extended access address using a third number of least significant bits (LSBs) of a pseudo-noise (PN) sequence to generate a pre-scrambled access address, the PN sequence including a fourth number of bits;
encoding the pre-scrambled access address such that the encoded pre-scrambled access address includes a same number of bits as the fourth number of bits in the PN sequence; and
post-scrambling the encoded pre-scrambled access address using the PN sequence with the fourth number of bits to generate the coded access address, the coded access address including the same number of bits as the fourth number of bits in the PN sequence;
generate the air interface packet including the coded access address; and
transmit the air interface packet using short-range communications to a second device.

11. The apparatus of claim 10, wherein the at least one processor is configured to encode the pre-scrambled access address such that the pre-scrambled access address includes the same number of bits as the fourth number of bits in the PN sequence by:
encoding the pre-scrambled access address such that an encoded pre-scrambled access address includes fewer than the fourth number of bits in the PN sequence to generate a fifth number of parity bits;
determining an additional parity bit; and
prepending the additional parity bit to the fifth number of parity bits to generate a parity bit sequence.

12. The apparatus of claim 11, wherein the parity bit sequence includes the same number of bits as the fourth number of bits in the PN sequence.

13. The apparatus of claim 11, wherein the at least one processor is configured to post-scramble the encoded pre-scrambled access address using the PN sequence with the fourth number of bits by:
modifying the additional parity bit; and
modifying the fifth number of parity bits.

14. The apparatus of claim 13, wherein the coded access address includes the modified additional parity bit, the modified fifth number of parity bits, and the extended access address.

15. The apparatus of claim 10, wherein the fourth number of bits is at least one-hundred and twenty-eight bits.

16. The apparatus of claim 10, wherein the air interface packet further comprises a preamble, an access code trailer, a rate indicator, a header, a payload, a cyclic redundancy check (CRC), a termination portion, and a supplemental portion.

17. The apparatus of claim 16, wherein the rate indicator indicates a modulation scheme used for modulating one or more of the header, the payload, and the CRC.

18. The apparatus of claim 10, wherein the at least one processor is further configured to:
modulate the air interface packet using a phase shift keying (PSK) modulation scheme.

19. An apparatus for wireless communication for a first device, comprising:
means for generating a coded access address for an air interface packet, the means for generating the coded access address being configured to:
generate an access address with a first number of bits;
append a second number of bits to the first number of bits of the access address to generate an extended access address;
pre-scramble the extended access address using a third number of least significant bits (LSBs) of a pseudo-noise (PN) sequence to generate a pre-scrambled access address, the PN sequence including a fourth number of bits;
encode the pre-scrambled access address such that the encoded pre-scrambled access address includes a same number of bits as the fourth number of bits in the PN sequence; and
post-scramble the encoded pre-scrambled access address using the PN sequence with the fourth number of bits to generate the coded access address, the coded access address including the same number of bits as the fourth number of bits in the PN sequence;
generate the air interface packet including the coded access address; and
transmit the air interface packet using short-range communications to a second device.

20. The apparatus of claim 19, wherein the means for generating the coded access address for the air interface packet is configured to encode the pre-scrambled access address such that the pre-scrambled access address includes the same number of bits as the fourth number of bits in the PN sequence by:
encoding the pre-scrambled access address such that an encoded pre-scrambled access address includes fewer than the fourth number of bits in the PN sequence to generate a fifth number of parity bits;
determining an additional parity bit; and
prepending the additional parity bit to the fifth number of parity bits to generate a parity bit sequence.

21. The apparatus of claim 20, wherein the parity bit sequence includes the same number of bits as the fourth number of bits in the PN sequence.

22. The apparatus of claim 20, wherein the means for generating the coded access address for the air interface packet is configured to post-scramble the encoded pre-scrambled access address using the PN sequence with the fourth number of bits by:
modifying the additional parity bit; and
modifying the fifth number of parity bits.

23. The apparatus of claim 22, wherein the coded access address includes the modified additional parity bit, the modified fifth number of parity bits, and the extended access address.

24. The apparatus of claim 19, wherein the fourth number of bits is at least one-hundred and twenty-eight bits.

25. The apparatus of claim 19, wherein the air interface packet further comprises a preamble, an access code trailer, a rate indicator, a header, a payload, a cyclic redundancy check (CRC), a termination portion, and a supplemental portion.

26. The apparatus of claim 25, wherein the rate indicator indicates a modulation scheme used for modulating one or more of the header, the payload, and the CRC.

27. The apparatus of claim 19, further comprising:
means for modulating the air interface packet using a phase shift keying (PSK) modulation scheme.

28. A computer-readable medium storing computer executable code for a first device, comprising code to:
generate a coded access address for an air interface packet by:
generating an access address with a first number of bits;
appending a second number of bits to the first number of bits of the access address to generate an extended access address;
pre-scrambling the extended access address using a third number of least significant bits (LSBs) of a pseudo-noise (PN) sequence to generate a pre-scrambled access address, the PN sequence including a fourth number of bits;
encoding the pre-scrambled access address such that the encoded pre-scrambled access address includes a same number of bits as the fourth number of bits in the PN sequence; and
post-scrambling the encoded pre-scrambled access address using the PN sequence with the fourth number of bits to generate the coded access address, the coded access address including the same number of bits as the fourth number of bits in the PN sequence;
generate the air interface packet including the coded access address; and
transmit the air interface packet using short-range communications to a second device.

29. The computer-readable medium of claim 28, wherein the code to encode the pre-scrambled access address such that the pre-scrambled access address includes the same number of bits as the fourth number of bits in the PN sequence is configured to:
encode the pre-scrambled access address such that an encoded pre-scrambled access address includes fewer than the fourth number of bits in the PN sequence to generate a fifth number of parity bits;
determine an additional parity bit; and
prepend the additional parity bit to the fifth number of parity bits to generate a parity bit sequence.

30. The computer-readable medium of claim 29, wherein the parity bit sequence includes the same number of bits as the fourth number of bits in the PN sequence.

31. The computer-readable medium of claim 29, wherein the code to post-scramble the encoded pre-scrambled access address using the PN sequence with the fourth number of bits is configured to:
modify the additional parity bit; and
modify the fifth number of parity bits.

32. The computer-readable medium of claim 31, wherein the coded access address includes the modified additional parity bit, the modified fifth number of parity bits, and the extended access address.

33. The computer-readable medium of claim 28, wherein the fourth number of bits is at least one-hundred and twenty-eight bits.

34. The computer-readable medium of claim 28, wherein the air interface packet further comprises a preamble, an access code trailer, a rate indicator, a header, a payload, a cyclic redundancy check (CRC), a termination portion, and a supplemental portion.

35. The computer-readable medium of claim 34, wherein the rate indicator indicates a modulation scheme used for modulating one or more of the header, the payload, and the CRC.

36. The computer-readable medium of claim 28, further comprising code to:
modulate the air interface packet using a phase shift keying (PSK) modulation scheme.
